(19) United States
(12) Patent Application Publication
(10) Pub. No.: US 2013/0163062 A1
(43) Pub. Date: Jun. 27, 2013

(54) MECHANICAL SMART WINDOW WITH CONTINUOUSLY TUNABLE TRANSMISSION

(71) Applicants: Fan Yang, Sunnyvale, CA (US); Wilhelmus Adrianus de Groot, Palo Alto, CA (US)

(72) Inventors: Fan Yang, Sunnyvale, CA (US); Wilhelmus Adrianus de Groot, Palo Alto, CA (US)

(73) Assignee: QUALCOMM MEMS TECHNOLOGIES, INC., San Jose, CA (US)

(21) Appl. No.: 13/334,494

(22) Filed: Dec. 22, 2011

(51) Int. Cl. G02B 26/02; B32B 37/14; B32B 37/02; G02B 27/28; B05D 5/06

(52) U.S. Cl. 359/228; 359/233; 359/486.01; 359/486.02; 427/162; 156/148; 156/145

(57) ABSTRACT

This disclosure provides systems, methods and apparatus for providing continuous light-transmissivity tuning through a mechanical smart window. In one aspect, a mechanical smart window including multiple layers is provided, each layer featuring light-blocking and light-transmitting areas. The layers may be moved relative to each other, changing the amount by which each light-blocking area occludes light-transmitting areas on other layers.

### TECHNICAL FIELD

This disclosure relates to smart glass or smart window electromechanical systems.

### DESCRIPTION OF THE RELATED TECHNOLOGY

Smart glass or smart windows generally refer to materials or structures which change their light transmission properties in response to an external stimulus. For example, a transparent or semi-transparent smart window may be rendered opaque when power is applied to the smart window. Smart glass is often used in architectural, interior design, or other applications. For example, next generation airplanes utilize smart glass window shades for passenger windows.

There are five main types of smart glass in use at present which are generally differentiated based on their fabrication technology. These five categories include liquid crystals, polymer-dispersed liquid crystals, electrochromic materials, suspended particle device, and reflective hydrides.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus including a plurality of layers including a first layer and a second layer. The first layer and the second layer may each include light-blocking areas and light-transmitting areas. A support structure may also be included in the apparatus and may be configured to support the first layer and the second layer. A control system may also be included in the apparatus and may be configured for moving at least one of the first and second layers between a first configuration and a second configuration with respect to each other. In the first configuration, the light-blocking areas of the first layer may substantially overlay, and may be substantially coextensive with, the light-blocking areas of the second layer and the light-transmitting areas of the first layer may substantially overlay, and may be substantially coextensive with, the light-transmitting areas of the second layer. In the second configuration, the light-blocking areas of the first layer may at least partially overlap the light-transmitting areas of the second layer, and the light-blocking areas of the second layer may at least partially overlap the light-transmitting areas of the first layer.

In a further implementation, the plurality of layers may include one or more intermediate layers disposed between the first layer and the second layer. Each intermediate layer may include light-blocking areas and light-transmitting areas. In the first configuration, the light-blocking areas of each intermediate layer may substantially overlay, and may be substantially coextensive with, the light-blocking areas of the first layer and the second layer, and the light-transmitting areas of each intermediate layer may substantially overlay, and may be substantially coextensive with, the light-transmitting areas of the first layer and the second layer. In the second configuration, the light-blocking areas of each layer may partially overlap the light-transmitting areas of the other layers. The control system may be further configured for moving the one or more intermediate layers between the first configuration and the second configuration.

In some implementations, each layer in the plurality of layers may be offset from any neighboring layer by a substantially equal distance in a direction substantially normal to the layers.

In some implementations, each light-blocking area of each layer in the plurality of layers is shifted by a substantially equal distance with respect to a corresponding light-blocking area of any neighboring layer in a direction substantially parallel to the layer when in the second configuration.

In a further implementation, the control system may be configured to move all of the layers in the plurality of layers between the first configuration and the second configuration simultaneously.

In some implementations, the support structure may be further configured to support the intermediate layers and prevent the first layer, the second layer, and the intermediate layers from contacting neighboring layers when the layers are in at least one of the first configuration and the second configuration.

In some implementations, each light-transmitting area of each layer may be completely overlapped by partial overlaps of the light-blocking areas of the other layers. In some further implementations, each layer in the plurality of layers may include a portion of a graphical image on one side and, in the second configuration, the portions of the graphical image may align to depict the graphical image.

In some implementations, the light-blocking areas and light-transmitting areas of each layer may form a periodic pattern. In some further implementations, the periodic pattern is may be a checkerboard pattern, a grid pattern of light-blocking areas with light-transmitting areas in the grid interstices, a grid pattern of light-transmitting areas with light-blocking areas in the grid interstices, a parallel-line grating pattern of light-blocking areas with a light-transmitting area between each light blocking area, or a grid pattern of light-blocking areas with light-transmitting areas in the grid interstices with the grid pattern oriented at approximately 45° to a direction of movement of the first layer.

In some implementations, at least one layer may be made of a transparent material and the light-blocking areas of the at least one layer may be formed on or in the transparent material. In some other implementations, the layers may each be made of an opaque material and the light-transmitting areas may be formed by interstices in the opaque material.

In some implementations, the area ratio of the light-blocking areas to the light-transmitting areas for a layer in the plurality of layers may be approximately 1:X, where X equals the number of layers in the plurality of layers minus 1.

In some implementations, the apparatus may also include at least one first pivot arm, with a first side of each layer rotatably connected with the at least one first pivot arm, and the at least one first pivot arm being configured to rotate about a first pivot point. Each layer may be configured to translate with respect to, and remain parallel to, the other layers during rotation of the at least one first pivot arm about the first pivot point.

In some implementations, the light-blocking areas of at least one layer may have a reflective coating on one side. Similarly, in some implementations, the light-blocking areas of at least one layer may have a non-reflective coating on one side.

In some implementations, the apparatus may include an enclosure including two substantially parallel, transparent or translucent walls suspended within the enclosure and substantially parallel to the two transparent or translucent walls. The apparatus may also include a fluid contained within the enclosure. The layers may be immersed in the fluid.

In some implementations, the light-blocking areas may block or reflect substantially all visible light incident on the light-blocking areas. In some other implementations, the light-blocking areas may be substantially transparent to light of a first wavelength incident on the light-blocking areas, and may substantially block or reflect light of a second, different, wavelength incident on the light-blocking areas. In yet some other implementations, the light-blocking areas may be substantially transparent to a first wavelength of light in the visible spectrum incident on the light-blocking areas, and may substantially block or reflect a second wavelength of the light in the ultraviolet or the infrared spectrum incident on the light-blocking areas.

In some implementations, the light-blocking areas may be substantially transparent to light with a first polarity incident on the light-blocking areas, and may substantially block or reflect light with a second, different, polarity incident on the light-blocking areas.

Another innovative aspect of the subject matter described in this disclosure can be implemented as a method of tuning light transmission through a structure. The method may include moving a first layer and a second layer between a first configuration and a second configuration. The first layer and the second layer may each include light-blocking areas and light-transmitting areas. In the first configuration, the light-blocking areas of the first layer may substantially overlay, and may be substantially coextensive with, the light-blocking areas of the second layer and the light-transmitting areas of the first layer may substantially overlay, and may be substantially coextensive with, the light-transmitting areas of the second layer. In the second configuration, the light-blocking areas of the first layer may at least partially overlap the light-transmitting areas of the second layer, and the light-blocking areas of the second layer may at least partially overlap the light-transmitting areas of the first layer.

In some implementations, the light blocking areas on the first layer may completely overlap the light-transmitting areas on the second layer and the light blocking areas on the second layer may completely overlap the light-transmitting areas on the first layer in the second configuration.

In some implementations, the method may further include moving each intermediate layer of one or more intermediate layers between the first configuration to the second configuration. Each intermediate layer may include light-blocking areas and light-transmitting areas and may be located between the first layer and the second layer. In the first configuration, the light-blocking areas of each intermediate layer may substantially overlay, and may be substantially coextensive with, the light-blocking areas of the first layer and the light-blocking areas of the second layer and the light-transmitting areas of each intermediate layer may substantially overlay, and may be substantially coextensive with, the light-transmitting areas of the first layer and the light-transmitting areas of the second layer. In the second configuration, the light-blocking areas of each layer may partially overlap the light-transmitting areas of the other layers.

In some implementations of the method, each light-transmitting area of each layer may be completely overlapped by the partial overlaps of the light-blocking areas of the other layers in the second configuration.

In some implementations, the moving of the first layer, the second layer, and the one or more intermediate layers may involve displacing each layer an equal amount with respect to any neighboring layers in a direction substantially parallel to the layers.

In some implementations of the method, the moving of the first layer, the second layer, and the one or more intermediate layers may involve displacing at least two layers of the first layer, the second layer, and the one or more intermediate layers in a first direction and a second direction, the first direction and the second direction substantially parallel to the layers but not substantially parallel to each other.

Another innovative aspect of the subject matter described in this disclosure can be implemented in an apparatus including a first layer including first means for blocking light and first means for transmitting light and a second layer including second means for blocking light and second means for transmitting light. The apparatus may also include means for moving the first layer and the second layer between a first configuration and a second configuration. The first means for blocking light may substantially overlay, and may be substantially coextensive with, the second means for blocking light and the first means for transmitting light may substantially overlay, and may be substantially coextensive with, the second means for transmitting light in the first configuration. The first means for blocking light may at least partially overlap the second means for transmitting light and the second means for blocking light may at least partially overlap the first means for transmitting light in the second configuration.

In some implementations, the apparatus may further include one or more intermediate layers, each intermediate layer including intermediate means for blocking light and intermediate means for transmitting light. The means for moving may be further configured for moving the one or more intermediate layers between the first configuration and the second configuration. In the first configuration, the one or more intermediate means for blocking light may substantially overlay, and may be substantially coextensive with, the first means for blocking light and the second means for blocking light and the one or more intermediate means for transmitting light substantially may overlay, and may be substantially coextensive with, the first means for transmitting light and the second means for transmitting light. In the second configuration, the means for blocking light for each layer may partially overlap each of the means for transmitting light on the other layers.

In some implementations, each means for transmitting light of each layer may be completely overlapped by partial overlaps of each means for blocking light of the other layers in the second configuration.

Another innovative aspect of the subject matter described in this disclosure can be implemented as a method of manufacturing a continuously-tunable light-transmissive device. The method may include forming a first layer, the first layer including light-transmitting areas and light-blocking areas, and forming a second layer, the second layer including light-transmitting areas and light-blocking areas. The light-transmitting areas and the light-blocking areas may be arranged in substantially the same manner on the first layer as they are on the second layer.

In some implementations, the method may further include forming the first layer by depositing an opaque material on a transparent substrate. In some other implementations, the method may further include forming the first layer by removing portions of material from an opaque substrate. In yet some other implementations, the method may include forming the first layer by weaving opaque strands together to form a mesh.

In some implementations, the method may also include connecting the first layer to a positioning mechanism and connecting the second layer to the positioning mechanism. The positioning mechanism may be configured to move the first layer and the second layer between a first configuration to a second configuration. In the first configuration, the light-blocking areas of the first layer may substantially overlay, and may be substantially coextensive with, the light-blocking areas of the second layer and the light-transmitting areas of the first layer may substantially overlay, and may be substantially coextensive with, the light-transmitting areas of the second layer. In the second configuration, the light-blocking areas of each layer may at least partially overlap the light-transmitting areas of the other layers.

In some implementations, the method may further include connecting one or more intermediate layers to the positioning mechanism and in between the first layer and the second layer. Each intermediate layer may include light-blocking areas and light-transmitting areas, and the positioning mechanism may be further configured to move each intermediate layer between the first configuration and the second configuration. In the first configuration, the light-blocking areas of each intermediate layer may substantially overlay, and may be substantially coextensive with, the light-blocking areas of the first layer and the light-blocking areas of the second layer and the light-transmitting areas of each intermediate layer may substantially overlay, and may be substantially coextensive with, the light-transmitting areas of the first layer and the light-transmitting areas of the second layer. In the second configuration, the light-blocking areas of each layer may partially overlap the light-transmitting areas of the other layers.

In some further implementations, the method may further include inserting the positioning mechanism and the connected first layer, second layer, and one or more intermediate layers into a gap between two pieces of transparent or translucent material fixed relative to each other and rigidly supporting at least one of the positioning mechanism, the first layer, the second layer, or the one or more intermediate layers with respect to the two pieces of transparent or translucent material. The method can further include joining the two pieces of transparent or translucent material to form an enclosure and filling the enclosure with a fluid.

Another innovative aspect of the subject matter described in this disclosure can be implemented in an apparatus including a first layer and a second layer, each of the first layer and the second layer having alternating first polarity areas and second polarity areas. The first polarity areas may be configured to polarize light substantially in a first plane and the second polarity areas may be configured to polarize light in a second plane that is substantially orthogonal to the first plane. The apparatus may also include a support structure configured to support the first layer and the second area and a control system configured for moving at least one of the first and second layers between a first configuration and a second configuration with respect to each other. In the first configuration, the first polarity areas of the first layer may substantially overlay, and may be substantially coextensive with, the first polarity areas of the second layer and the second polarity areas of the first layer may substantially overlay, and may be substantially coextensive with, the second polarity areas of the second layer. In the second configuration, the first polarity areas of the first layer may at least partially overlap the second polarity areas of the second layer, and the first polarity areas of the second layer may at least partially overlap the second polarity areas of the first layer.

In some further implementations of the apparatus, the first polarity areas and second polarity areas may be arranged in a linear pattern array. In some other further implementations of the apparatus, the first polarity areas and second polarity areas may be arranged in a checkerboard pattern.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a plan view of an example of a first layer for a two-layer implementation of a mechanical smart window.

FIG. 1B shows an example of the base pattern for the first layer of FIG. 1A.

FIG. 1C shows a plan view of an example of a second layer for a two-layer implementation of a mechanical smart window.

FIG. 1D shows a plan view of an example of a mechanical smart window including the first layer of FIG. 1A and the second layer of FIG. 1C in a maximum light-transmissivity state.

FIG. 1E shows a plan view of the example of the mechanical smart window shown in FIG. 1D with the two layers shifted relative to each other.

FIG. 1F shows a plan view of the example of the mechanical smart window shown in FIG. 1D with the two layers shifted relative to each other to achieve a minimum light-transmissivity state.

FIG. 2A shows a plan view of an example of a first layer for a two-layer implementation of a mechanical smart window with a base pattern including more light-blocking area than light-transmitting area.

FIG. 2B shows an example of the base pattern for the first layer of FIG. 2A.

FIG. 2C shows a plan view of an example of a second layer for a two-layer implementation of a mechanical smart window with the base pattern of FIG. 2A.

FIG. 2D shows a plan view of an example of a two-layer implementation of a mechanical smart window including the first layer of FIG. 2A and the second layer of FIG. 2C in the minimum light-transmissivity state.

FIG. 2E shows a plan view of the example of the mechanical smart window shown in FIG. 2D, but with the first layer made semi-transparent to allow the second layer to be seen simultaneously with the first layer.

FIG. 2F shows a plan view of the example of the mechanical smart window shown in FIG. 2D, but with the first layer made semi-transparent to allow the second layer to be seen simultaneously, and with the first layer shifted to allow for some light transmission through the layers.

FIG. 2G shows a plan view of the example of the mechanical smart window shown in FIG. 2D, but with the first layer made semi-transparent to allow the second layer to be seen simultaneously with the first layer, and with the first layer shifted with respect to the second layer to allow for maximum light-transmissivity.

FIG. 3 shows a side view of a portion of an example of a mechanical smart window implementation with two layers and equal-sized light-transmitting and light-blocking areas.

FIG. 4 shows a side view of the portion of the example of the mechanical smart window of FIG. 3, but with a reduced gap between the two layers.

FIG. 5 shows a side view of a portion of an example of a mechanical smart window implementation with two layers and light-blocking areas which are larger than the light-transmitting areas.

FIG. 6A shows a plan view of examples of layers for use in a mechanical smart window with nine layers.

FIG. 6B shows an example of a base pattern for the layers of FIG. 6A.

FIG. 6C shows a plan view of an example of a mechanical smart window with nine layers in the minimum light-transmissivity state.

FIG. 6D shows a plan view of the example of the mechanical smart window shown in FIG. 6C in moderate light-transmissivity state.

FIG. 6E shows a plan view of the example of the mechanical smart window shown in FIG. 6C in the maximum light-transmissivity state.

FIG. 7A shows a plan view of an example of a first layer with a diagonal grid pattern for use in a mechanical smart window with four layers.

FIG. 7B shows an example of a base pattern for the first layer of FIG. 7A.

FIG. 7C shows a plan view of an example of a mechanical smart window using the first layer of FIG. 7A and three additional layers; the resulting mechanical smart window with four layers is shown in an intermediate light-transmissivity state.

FIG. 7D shows a plan view of the example of the mechanical smart window shown in FIG. 7C with the layers shifted to produce the minimum light-transmissivity state.

FIG. 8A shows a side view of an example of a mechanical smart window with a parallel linkage mechanism.

FIG. 8B shows a side view of the example of the mechanical smart window shown in FIG. 8A in the minimum light-transmissivity state.

FIG. 8C shows a side view of the example of the mechanical smart window shown in FIG. 8A in the maximum light-transmissivity state.

FIG. 9A shows a side view of an example of a mechanical smart window with four layers, a parallel linkage mechanism, and a linear actuator with the mechanical smart window in the maximum light-transmissivity state.

FIG. 9B shows a detail view of a portion of the example of the mechanical smart window shown in FIG. 9A.

FIG. 9C shows a side view of the example of the mechanical smart window shown in FIG. 9A with the mechanical smart window in the minimum light-transmissivity state.

FIG. 10 shows a high-level block diagram of an example of a mechanical smart window system.

FIG. 11 shows a flow diagram for an example of an implementation of a manufacturing technique for producing some mechanical smart windows according to this disclosure.

FIG. 12A shows a side view of an example of a mechanical smart window with four layers and a spool drive mechanism in the minimum light-transmissivity state.

FIG. 12B shows a side view of the example of the mechanical smart window shown in FIG. 12A in the maximum light-transmissivity state.

FIG. 13A shows a side view of an example of a mechanical smart window with three layers and a spool drive mechanism with the mechanical smart window in the maximum light-transmissivity state.

FIG. 13B shows a side view of the example of the mechanical smart window shown in FIG. 13A with the mechanical smart window in a reflective minimum light-transmissivity state.

FIG. 13C shows a side view of the example of the mechanical smart window shown in FIG. 13A with the mechanical smart window in an absorptive minimum light-transmissivity state.

FIG. 14A shows a plan view of an example of a first layer for a four-layer mechanical smart window with portions of a graphic in the light-blocking areas.

FIG. 14B shows an example of a base pattern for the first layer of FIG. 14A.

FIG. 14C shows a plan view of an example of a mechanical smart window using the first layer of FIG. 14A and three additional layers with portions of the graphic in the light-blocking areas; the mechanical smart window is shown in an intermediate light-transmissivity state.

FIG. 14D shows a plan view of the example of the mechanical smart window shown in FIG. 14C in the minimum light-transmissivity state.

FIG. 14E shows a plan view of the example of the four individual layers of the mechanical smart window shown in FIGS. 14C and 14D.

FIG. 15A shows a plan view of an example of a mechanical smart window with four layers including a light-transmissivity graphic with the mechanical smart window in the minimum light-transmissivity state.

FIG. 15B shows a detail view of a portion of one layer of the example of the mechanical smart window shown in FIG. 15A.

FIG. 15C shows a plan view of the example of the mechanical smart window of FIG. 15A in the maximum light-transmissivity state.

FIG. 16A shows a plan view of an example of a first layer for a mechanical smart window utilizing polarizers.

FIG. 16B shows an example of a base pattern for the first layer of FIG. 16A.

FIG. 16C shows a plan view of an example of a mechanical smart window utilizing the first layer of FIG. 16A in a maximum light-transmissivity state.

FIG. 16D shows a plan view of the example of the mechanical smart window shown in FIG. 16C in an intermediate light-transmissivity state.

FIG. 16E shows a plan view of the example of the mechanical smart window shown in FIG. 16C in a minimum light-transmissivity state.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be used in any device that is configured to transmit or block light, whether from natural sources (for example, sunlight, moonlight, etc.) or artificial (for example, fluorescent lights, incandescent lights, LED lights, illuminated LCDs, etc.). More particularly, it is contemplated that the implementations may be used in or associated with a wide variety of applications, such as, but not limited to, architectural materials, residential and commercial construction, interior design, museum artwork expositions, high-end appliances, advanced displays, automotive mirrors, and privacy or security glass.

Various implementations described herein involve providing a mechanical smart glass or window with at least two layers arranged in a stacked formation where the at least two layers are movable with respect to each other between a first configuration and a second configuration. The layers have a transmissivity tuning region which includes a repeating base pattern of light-blocking areas and light-transmitting areas. In the first configuration, light-transmitting areas of the base patterns of each layer substantially overlay each other such that light can be transmitted through the stacked formation. When in the second configuration, the light-blocking areas of the base patterns of each layer at least partially overlay the light-transmitting areas of at least one other layer such that less light is transmitted from one side of the stacked formation to the other side than when the mechanical smart window is in the first configuration. The layers may be housed between two stationary transparent layers in some implementations, such as between the panes of a double-glazed window.

Such implementations allow for the light-transmissivity of the window to be continuously tunable between the maximum and minimum light-transmissivity supported by the layers. Very little or no power would be required to maintain any particular level of transmissivity supported by such implementations. As used herein, the “maximum light-transmissivity state” of a mechanical smart window implementation refers to the mechanical state into which the mechanical smart window may be placed which results in the maximum amount of light-transmissivity through the mechanical smart window. Conversely, the “minimum light-transmissivity state” of a mechanical smart window implementation refers to the mechanical state into which the mechanical smart window may be placed which results in the minimum amount of light-transmissivity through the mechanical smart window. In many implementations, the minimum light-transmissivity state may result in substantially all light perpendicularly-incident to the transmissivity tuning region of the mechanical smart window being blocked. In other implementations, however, some perpendicularly-incident light may still be transmitted through a mechanical smart window implementation in the minimum light-transmissivity state.

Particular implementations of the subject matter described in this disclosure may be implemented to realize one or more of the following potential advantages. For example, some implementations may allow for the amount of light transmitted through a window or other transparent structure to be continuously tuned over a wide range of transmissivity, which may provide greater transmissivity tuning options as compared with digital smart window technology. Some such implementations may require very little or no power to maintain light-transmissivity at a desired level and may only require higher levels of power when the transmissivity is changed, which allows for reduced power consumption. Furthermore, some such implementations may possess a very thin form factor in one dimension, allowing them to be integrated with existing window architectures, such as double-glazed windows.

Some additional implementations, in addition to allowing for such continuous tuning of light-transmissivity, may allow light which is not transmitted through the window to be reflected away from the window using a broad-spectrum, high-specularity material. Other additional implementations may allow for selective, diffuse reflection of blocked light in order to present a particular color.

Some implementations may also be used to transform a mechanical smart window from a light-transmitting state to a light-opaque graphic image, such as a photograph, text, or other work.

Some implementations may also allow for a mechanical smart window which may be placed in either of two different light-blocking states, or in a range of intermediate light-blocking states bounded by the two different light-blocking states. For example, a mechanical smart window implementation may be configured to reflect blocked light away from the mechanical smart window in one light-blocking state in order to reduce heating of a building when the outside temperature is high. The same mechanical smart window implementation may also be configured to absorb light while in a second light-blocking state in order to promote the absorption of light energy by the building when the outside temperature is low. Thus, such a mechanical smart window implementation allows for more efficient use of external environmental conditions to maintain a human-comfortable environment inside of buildings using such a mechanical smart window implementation.

Various terms which imply a particular orientation with respect to the environment, such as, but not limited to, “vertical,” “horizontal,” “upper,” “lower,” “right,” “left,” “up,” and “down,” are used in conjunction with the drawings to aid in understanding the concepts described herein. Use of such terms should not be interpreted as requiring that such orientations be used in implementing the concepts described herein, unless a particular concept requires the described orientation to function. Another term used herein which should not be construed as conveying a particular ordering of parts is “overlay,” “overlaid,” or the like. For example, a layer which overlays another layer may also be viewed as “underlaying” the other layer if viewed from another, opposing perspective. Similarly, the other layer may be viewed as “overlaying” the layer in such an alternate perspective. The use of “overlaid” should also not be construed as requiring a layered configuration with a layering axis aligned in the vertical direction; layers or areas may be overlaid even when such areas or layers are layered in a non-vertical direction. In general, the systems and mechanisms described herein may be implemented in any of several orientations, and such other orientations are contemplated as being within the scope of this disclosure.

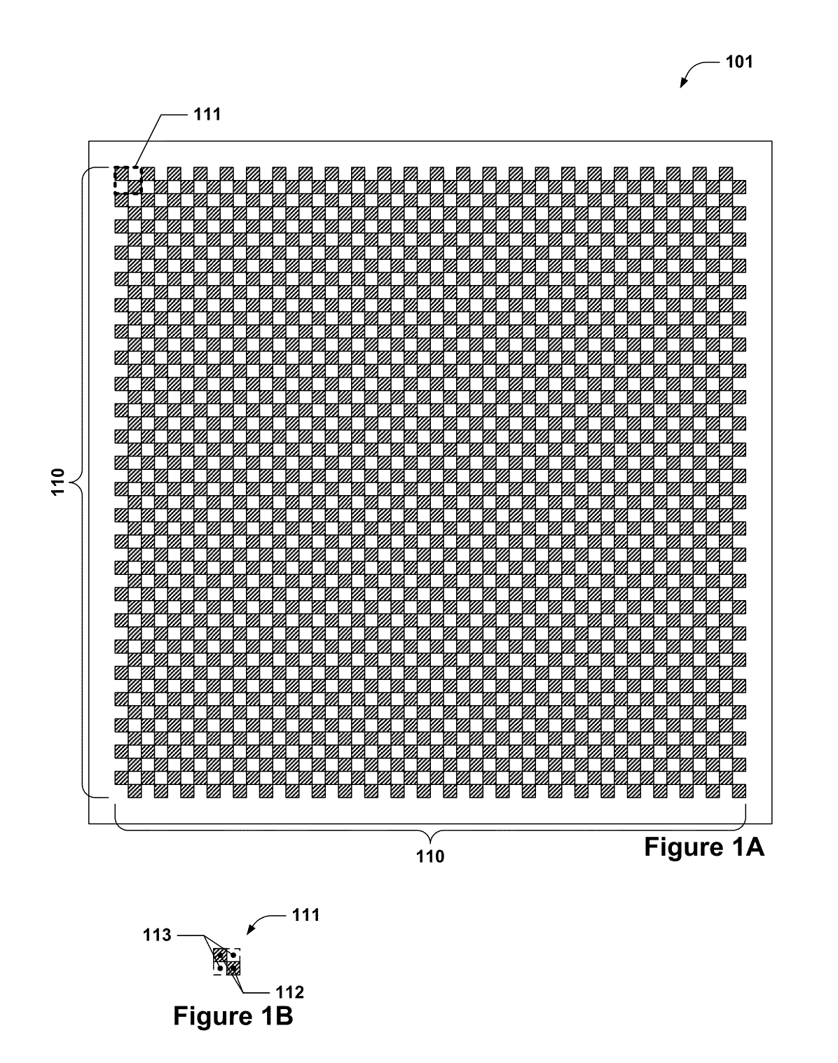

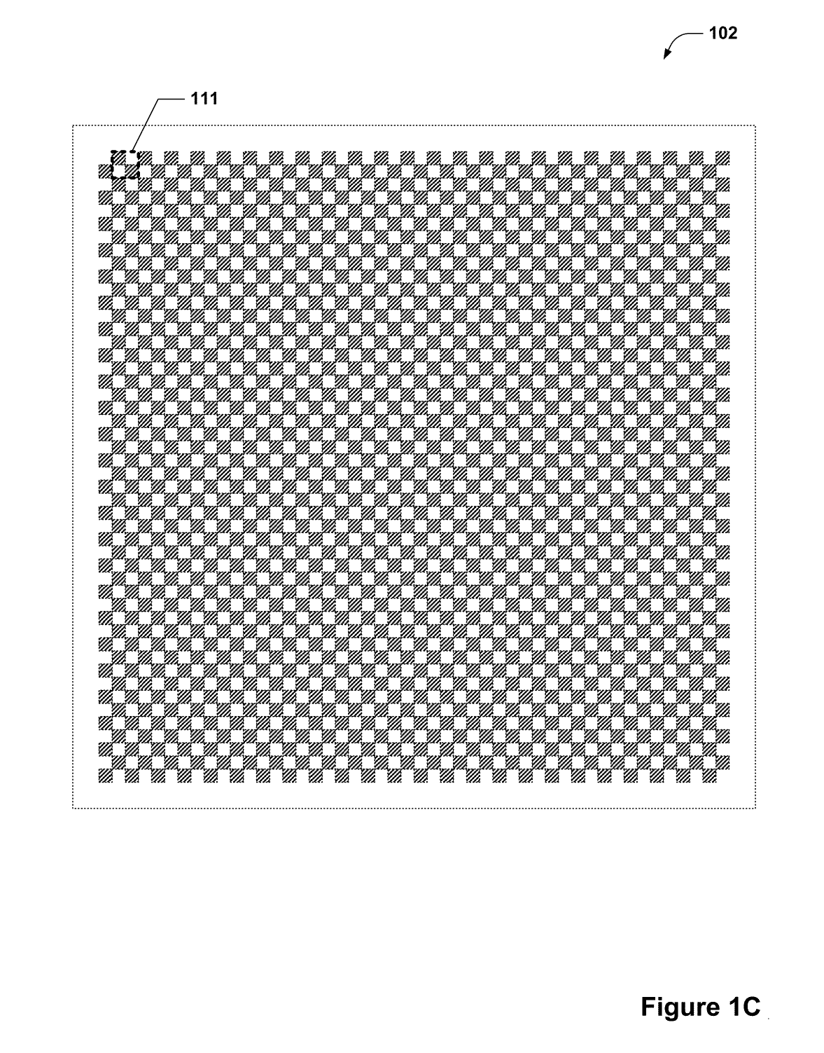

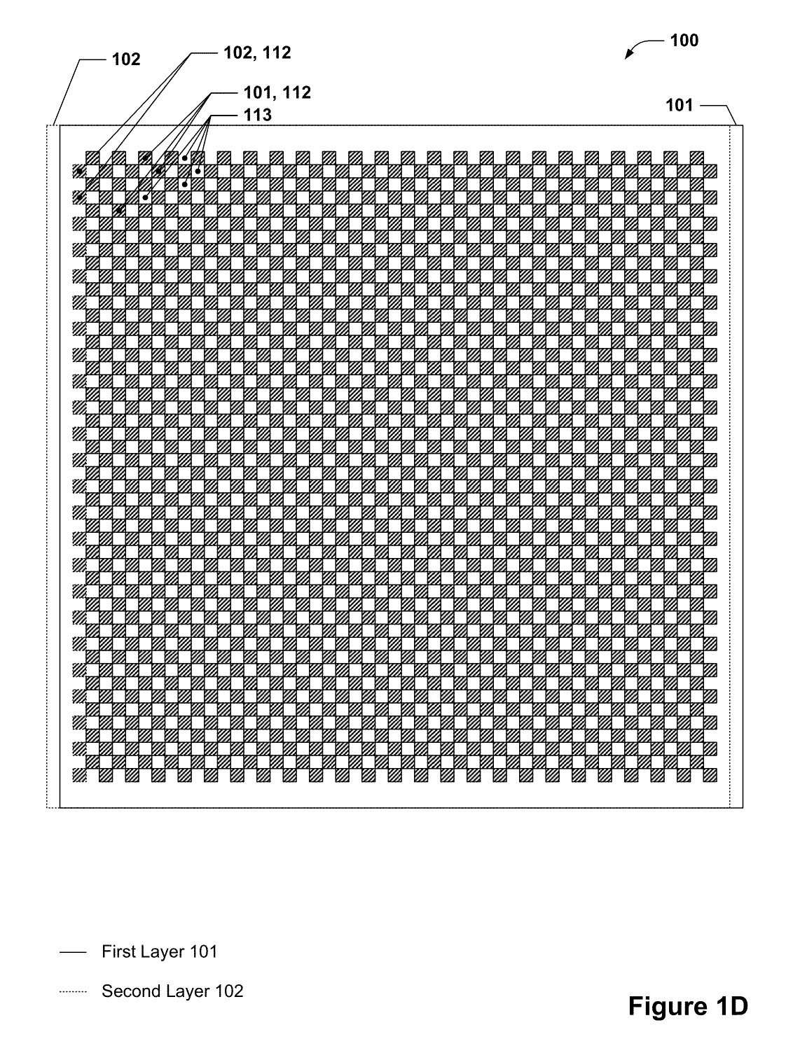

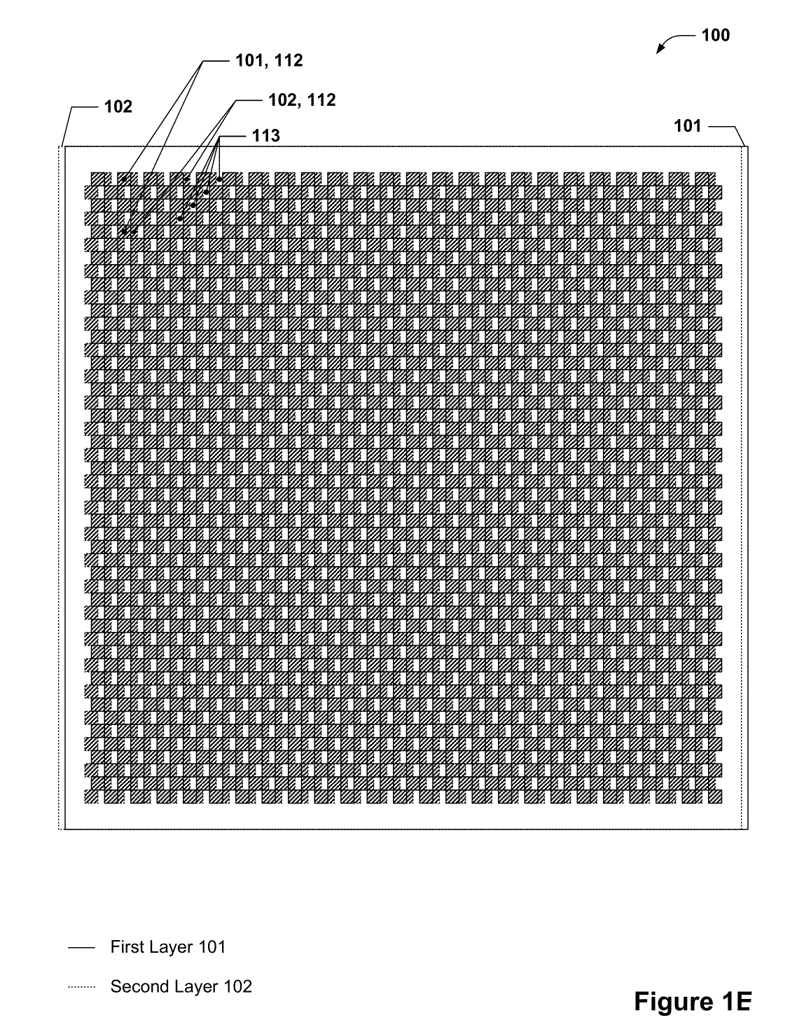

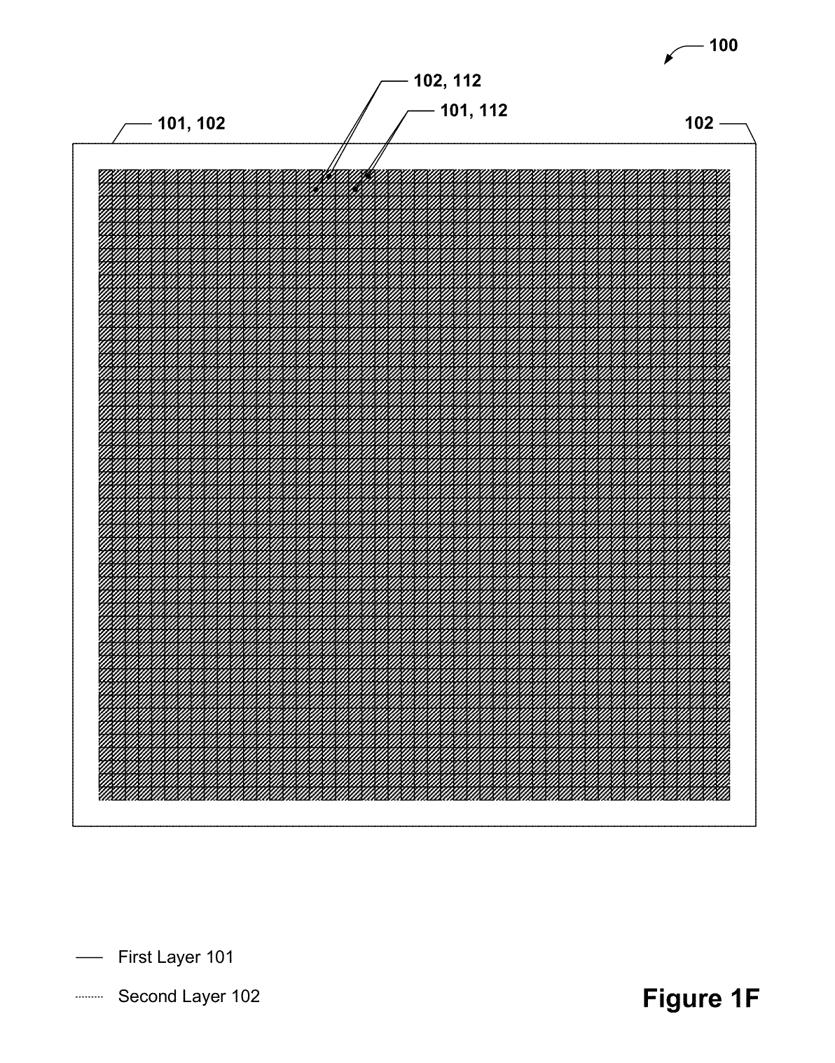

In some implementations, a mechanical smart window implementation such as that shown in FIGS. 1A-1F is provided. The example implementations shown in FIGS. 1A-1F may be used to provide an example two-layer mechanical smart window design. FIGS. 1A-1F are not drawn to scale, and may depict only some elements which may be used to implement the example mechanical smart window.

FIG. 1A shows a plan view of an example of a first layer for a two-layer implementation of a mechanical smart window. A first layer 101 of mechanical smart window 100 of FIG. 1A, may, for example, be made of a substantially transparent material. A base pattern 111 of light-blocking areas 112 and light-transmitting areas 113 reproduced in a repeating manner across the first layer 101.

FIG. 1B shows an example of the base pattern for the first layer of FIG. 1A. In the implementation shown in FIG. 1A, the base pattern 111 is repeated using a 24×24 pattern array, which forms a “checkerboard” pattern, although other pattern arrays may be used as well. For example, a rectangular pattern array may be used instead of a square pattern array. The number of repetitions of the base pattern 111 may also be adjusted as needed depending on the size of the first layer 101, the size of the transmissivity tuning region, and the size of the light-blocking areas 112 and the light-transmitting areas 113, etc. In some implementations, other pattern array types which periodically repeat the base pattern 111 may be used to accommodate other shapes for the light-blocking areas 112 and light-transmitting areas 113, such as a single-dimensional linear array or a hexagonal array. The pattern array of the light-transmitting areas 113 and the light-blocking areas 112 may generally define the transmissivity tuning region, for example, transmissivity tuning region 110 in FIG. 1A. The size of a pattern array may be generally defined by the number of instances of the base pattern 111 within the pattern array. For example, a 100×100 pattern array would have 10,000 instances of the base pattern 111.

FIG. 1C shows a plan view of an example of a second layer for a two-layer implementation of a mechanical smart window. A second layer 102 of FIG. 1C, may, for example, be made from a similar material as that used for the first layer 101. The second layer 101 may also have the base pattern 111 of the light-blocking areas 112 and the light-transmitting areas 113 reproduced in a repeating manner across the second layer 102. In the implementation shown in FIG. 1C, the base pattern 111 is repeated 24 times in the vertical direction (with respect to the orientation of FIG. 1C) and is also repeated 24 times in the horizontal direction, although with the base pattern 111 shifted by half of the width of the base pattern 111. For example, the left-most instance of the base pattern 111 in the top row of the base patterns 111 includes only the right half of the base pattern 111, and the right-most instance of the base pattern 111 in the top row of the base patterns 111 includes only the left half of the base pattern 111. The other 23 instances of the base pattern 111 in the top row of the base patterns 111 include complete the base patterns 111.

FIG. 1D shows a plan view of an example of a mechanical smart window including the first layer of FIG. 1A and the second layer of FIG. 1C in a maximum light-transmissivity state. FIG. 1D shows a mechanical smart window 100 with the first layer 101 overlaid on top of the second layer 102 such that the light-blocking areas 112 of the first layer 101 overlap and are substantially coextensive with the light-blocking areas 112 of the second layer 102. Due to the horizontal pattern-shift of the base pattern 111 in the second layer 102, such a configuration may cause the first layer 101 and the second layer 102 to be offset from each other by half of the width of the base pattern 111. In FIG. 1D, the first layer 101 is offset to the right of the second layer 102. In the implementations shown in FIGS. 1A-1F, the first layer 101 and the second layer 102 are both the same overall size and the transmissivity tuning regions are spaced similar distances from the edges of the first layer 101 and the second layer 102, respectively. It is to be understood that the spacing of the transmissivity tuning region from the edges of each individual layer may be determined as needed and may, in some implementations, be a zero spacing. In some implementations, a variety of different spacings may be used. In some implementations, differently-sized layers may be used. This may result in different edge offsets from those shown in FIGS. 1A-1F.

As can be seen in FIG. 1D, most of the light-transmitting areas 113 of the first layer 101 are overlaid or aligned with the light-transmitting areas 113 of the second layer 102. It is to be understood that, at the edges of instances of the base patterns 111 (not separately called out in FIG. 1D) which do not abut with a neighboring instance of the base pattern 111, there may not be overlap of the light-transmitting areas 113 from both the first layer 101 and the second layer 102. Thus, the instances of the base patterns 111 at the perimeter of the pattern array may not provide for tunable transmissivity in the same manner as the instances of the base patterns 111 which do abut with other instances of the base pattern 111 on all sides. As pattern array size increases, the number of instances of the base pattern 111 in the pattern array increases and the ratio of the instances of the base pattern 111 at the perimeter of the pattern array to the instances of the base pattern 111 within the perimeter of the pattern array decreases, and any light-transmissivity anomalies due to edge effects will become less and less noticeable with respect to the overall behavior of the mechanical smart window 100.

FIG. 1E shows a plan view of the example of the mechanical smart window shown in FIG. 1D with the two layers shifted relative to each other. More specifically, FIG. 1E shows the mechanical smart window 100 with the first layer 101 shifted to the left with respect to the second layer 102 such that the base patterns 111 on the first layer 101 are offset to the left from the base patterns 111 on the second layer 102 by approximately 25% of the width of the base pattern 111. This causes the light-blocking areas 112 on the first layer 101 and the second layer 102 to overlap with the light-transmitting areas 113 on the second layer 102 and the first layer 101, respectively, by approximately 50%, which reduces the amount of light which may be transmitted through the base patterns 111 of the first layer 101 and the second layer 102 by approximately 50%. For example, in the configuration shown in FIG. 1D, the light-transmitting areas 113 and the light-transmitting areas 112 of the two layers are aligned, which allows approximately 50% of the light striking the base patterns 111 of the first layer 101 and the second layer 102 to pass through both the first layer 101 and the second layer 102. However, in the configuration shown in FIG. 1E, only about 25% of light striking the base patterns 111 of the first layer 101 and the second layer 102 may pass through both the first layer 101 and the second layer 102 without striking the light-blocking areas 112 on the second layer 102 or the first layer 101, respectively, due to the partial overlap of the light-transmitting areas 112 and light-blocking areas 113 of the first layer 101 and the second layer 102.

The amount of light transmitted through the first layer 101 and the second layer 102 may be varied depending on the amount by which the first layer 101 and the second layer 102 are moved relative to each other. Because the amount of light transmitted through the layers is dependent on the amount by which the layers are moved or shifted relative to each other, the amount of light transmitted through the layers may, in effect, be tuned to any desired level subject to the precision with which the layers may be shifted. Some example layer movement mechanisms are discussed later in this paper.

FIG. 1F shows a plan view of the example of the mechanical smart window shown in FIG. 1D with the two layers shifted relative to each other to achieve a minimum light-transmissivity state. More specifically, FIG. 1F shows the mechanical smart window 100 with the first layer 101 shifted to the left with respect to the second layer 102 such that the base pattern 111 of the first layer 101 is shifted to the left of the base pattern 111 of the second layer 102 by 50% of the width of the base pattern 111. This causes the light-blocking areas 112 of first layer to completely overlap with the light-transmitting areas 113 of the second layer 102, and the light-blocking areas 112 of the second layer 102 to completely overlap with the light-transmitting areas 113 of the first layer 101, which prevents substantially all light striking the base patterns 111 of the first layer 101 and the second layer 102 from passing through the first layer 101 and the second layer 102.

The first layer 101, as well as other layers discussed herein with respect to this and other implementations, may be manufactured from a substantially transparent material. For example, glass, acrylic, UV-stabilized acrylic, or other polymers may be used as the substantially transparent material.

The light-blocking areas 112 may be formed by applying an opaque material to the substantially transparent material forming the first layer 101. Such opaque material may be applied to the first layer 101 using, for example, deposition techniques such as silk-screening, inkjet printing, stencil lithography, a thin-film deposition technique, such as shadow mask deposition, or other deposition technique. In some implementations, the transparent layer material may be recessed, for example, through etching or other material-removal process. Opaque material, such as ink or paint, may be placed in the recesses. Such recessed light-blocking areas may reduce friction and wear on the layers of a mechanical smart window, especially if the layers are in contact with each other during operation, since opaque material added to the substantially transparent material to produce the light-blocking areas does not contact the other layers due to being recessed. In some implementations, light-blocking material may be sealed between two layers of substantially transparent material, forming a laminate layer with integral light-blocking areas sandwiched in the middle.

In some implementations, the substantially transparent material forming the first layer 101 may be processed to cause the substantially transparent material to turn opaque in the light-blocking areas 112. For example, a laser may be used to burn the light-blocking areas 112 into the first layer 101. The burning process may cause the substantially transparent material to turn opaque in the area which is burned.

In some implementations, the layers may instead be made of an opaque material and light-transmitting areas may instead be formed by removing material. For example, a thin metal film or foil may be subjected to a stamping process which stamps material out in regions corresponding to the light-transmitting areas. In some implementations, the material removal may be the result of an etching process. In some other implementations, the layers may be manufactured from an opaque material and the light-transmitting areas may simply be created simultaneously with the opaque material. For example, a thin-film metal deposition process may be used to produce a layer with voids in it corresponding to the light-transmitting areas. In another example, a layer may be formed by a mesh. The mesh may be a woven mesh or a flat-formed (non-woven) mesh. With mesh layers, the interstices between mesh fibers may correspond with the light-transmitting areas, and the mesh fibers may correspond with the light-blocking areas. The mesh fibers may be generally round or flat and rectangular in cross-section.

While different layers in a single mechanical smart window may be made from different materials, care should be taken to match the thermal expansion coefficients between the materials to avoid misalignment of the light-blocking areas and light-transmitting areas due to different thermal expansion gradients across layers.

The layers of a mechanical smart window may be of various sizes, and may be suitable for use in, for example, commercial or residential windows. The thickness of the layers may be dependent on the manufacturing method selected for making the layers. For example, a polymer layer material may be on the order of 10-200 microns in thickness, whereas a thin-film layer of aluminum may be 100-200 nanometers in thickness. The material used to provide the light-blocking areas may also add to the layer thickness. For example, light-blocking areas formed by paint or other pigment may increase the maximum layer thickness by several microns. Thicker materials may also be used if appropriate, although thicker materials will be heavier and may require additional structural support and more robust movement mechanisms.

The nominal size of the base pattern in the direction of layer movement, referred to hereinafter as “pitch,” may range, for example, between 100 microns to 2 millimeters. Other pitch values may be used as well. For example, a larger pitch, such as 0.2 inches, may be used for mechanical smart windows which are physically distant from most observers, such as skylights or other elevated windows. The minimum pitch may be limited, in part, by the number of layers in the mechanical smart window and the technology used to produce the light-blocking and light-transmitting areas. For example, if a screen printing process capable of a minimum feature size of 50 microns is used to print light-blocking areas onto a transparent substrate, the pitch may be a function of the 50 micron minimum feature size, the desired minimum and maximum light-transmissivity supported, and the number of layers in the mechanical smart window. If, in the previous example, the mechanical smart window is a four-layer mechanical smart window and is desired to have zero perpendicularly-incident light-transmissivity in the minimum light-transmissivity state and to maximize such light transmission in the maximum light-transmissivity state, the pitch would be approximately 200 microns if the smallest possible screen-printable light-blocking areas were to be used.

While the mechanical smart windows discussed herein may be discussed as blocking or transmitting “perpendicularly-incident” light, it is to be understood that such terminology is used as an aid to discussion, and that mechanical smart windows may also block or transmit obliquely-incident light as well as perpendicularly-incident light. For example, while a mechanical smart window may block all perpendicularly-incident light when in the minimum light-transmissivity state, oblique light may still seep through, as discussed later in this paper. For many applications, the majority of light passing through a window will be perpendicularly-incident or nearly perpendicularly-incident.

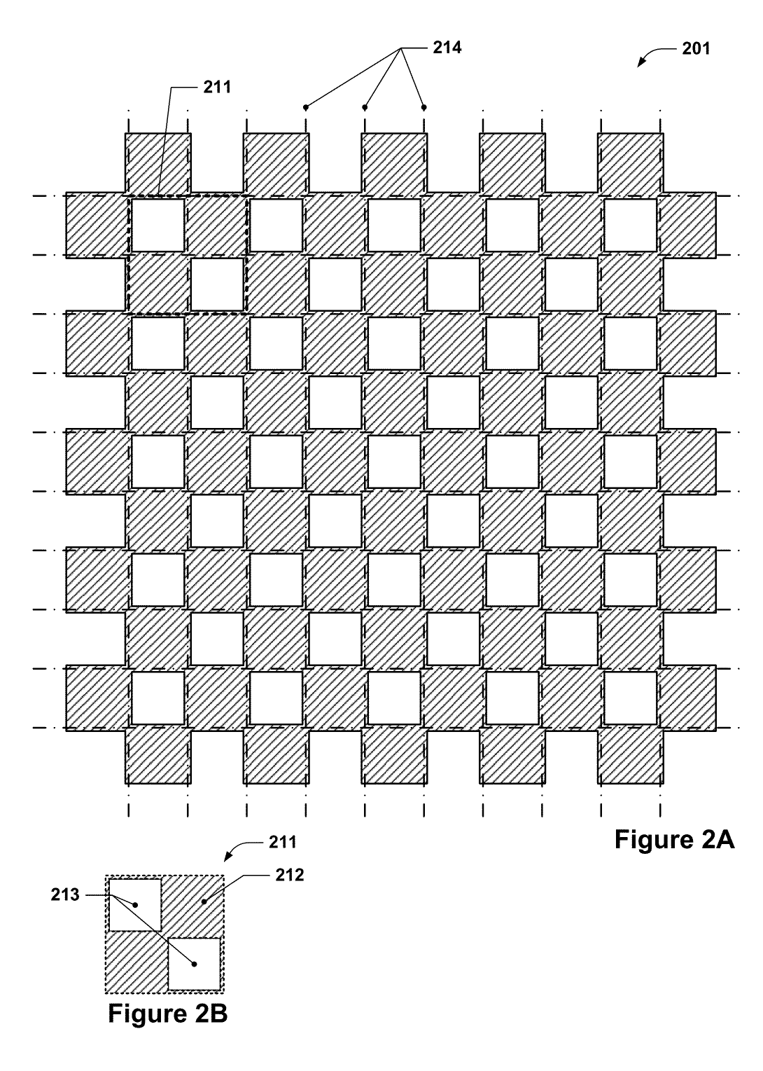

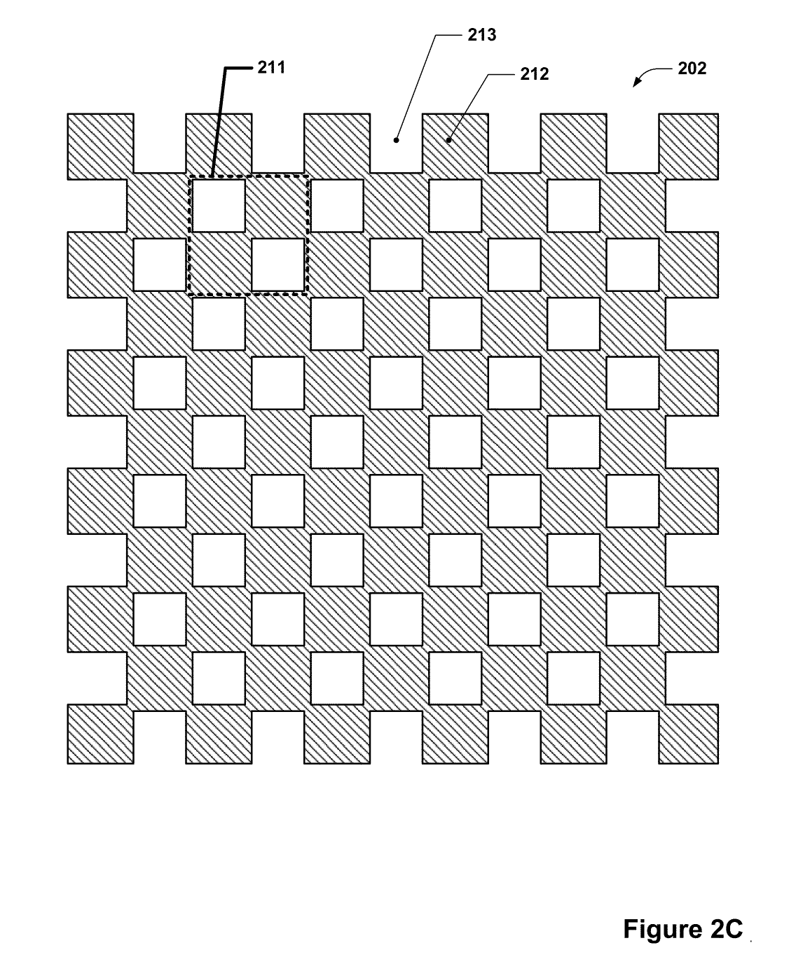

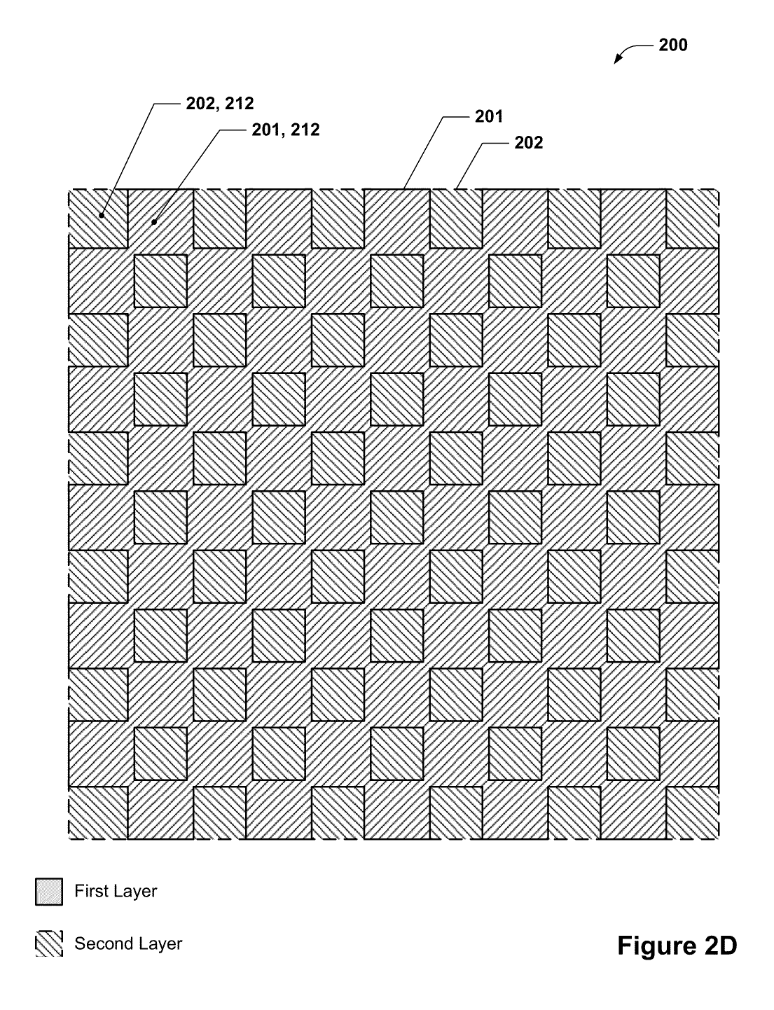

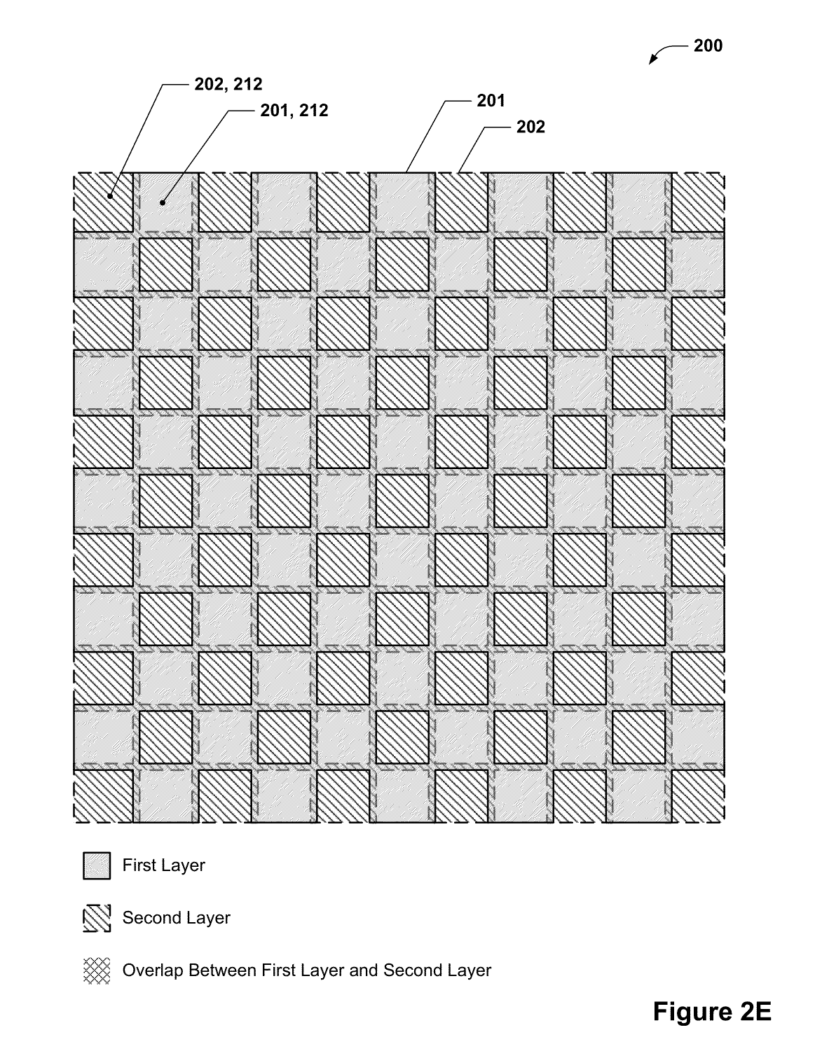

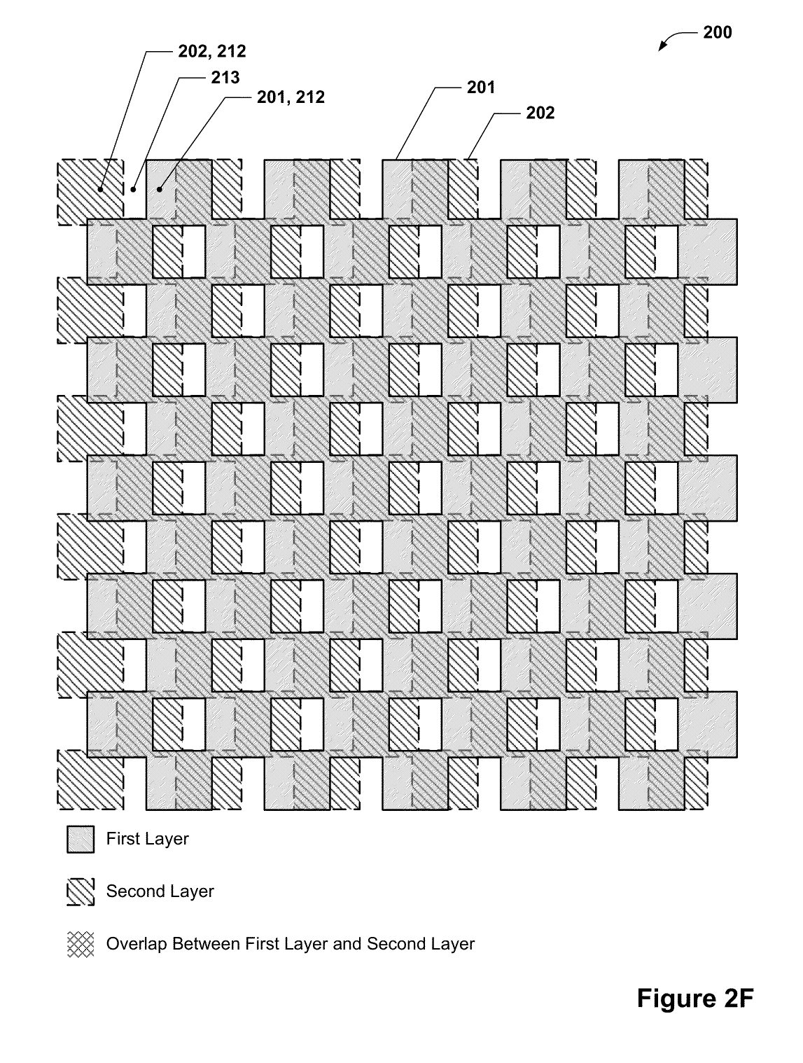

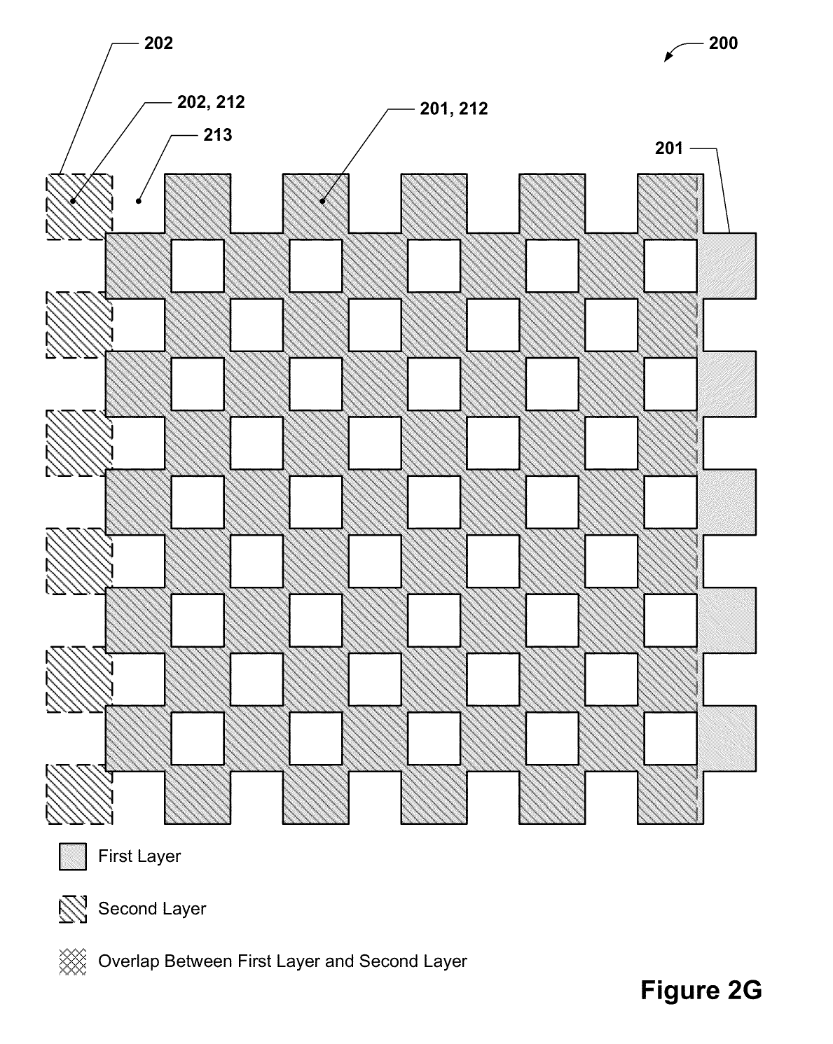

FIGS. 2A-2G depict another two-layer mechanical smart window design, for example, mechanical smart window 200, similar to that shown in FIGS. 1A-1F. In FIGS. 1A-1F, the ratio of the light-blocking area 112 to the light-transmitting area 113 within the base pattern 111 is 1:1. However, by contrast, the implementations shown in FIGS. 2A-2G feature a greater ratio of a light-blocking area 212 to a light-transmitting area 213 within a base pattern 211. A grid 214 represents a hypothetical 1:1 ratio between light-blocking areas and light-transmitting areas, similar to that used in FIGS. 1A-1F; the grid 214 is for the reader's reference and may not actually be present. The base pattern 211 is not separately called out in FIGS. 2C-2G, although the base pattern 211 is nonetheless apparent in these figures.

FIG. 2A shows a plan view of an example of a first layer for a two-layer implementation of a mechanical smart window with a base pattern including more light-blocking area than light-transmitting area. A first layer 201 shown in FIG. 2A includes light-blocking areas 212 and light-transmitting areas 213. The base pattern 211 is similar to the base pattern 111 from FIGS. 1A-1F, except that the ratio of the light-blocking area 212 to the light-transmitting area 213 in base pattern 211 is greater than 1:1. In a two-layer mechanical smart window using such layers, this may cause a light-blocking area 212 overlaid with a light-transmitting area 213 of another layer to overlap the boundaries of the light-transmitting area 213 of the other layer.

FIG. 2B shows an example of the base pattern for the first layer of FIG. 2A. In the implementation shown in FIGS. 2A-2G, the base pattern 211 may not be entirely replicated at the edges of the pattern array. It is to be recognized that some departure from the base pattern 211 may be practiced along edges of the base pattern 211 which do not abut other the base patterns 211 without affecting the overall operation of the mechanical smart window 200.

FIG. 2C shows a plan view of an example of a second layer for a two-layer implementation of a mechanical smart window with the base pattern of FIG. 2A. A second layer 202 shown in FIG. 2C includes the base pattern 211 of the light-blocking areas 213 and the light-transmitting areas 212. In the implementation shown, the base pattern 211 for the second layer 202 is horizontally shifted approximately half of the width of base pattern 211. Each row of the base patterns 211 is initiated and terminated by approximately half of the base pattern 211.

FIG. 2D shows a plan view of an example of a two-layer implementation of a mechanical smart window including the first layer of FIG. 2A and the second layer of FIG. 2C in the minimum light-transmissivity state. FIG. 2D shows the mechanical smart window 200 with the first layer 201 overlaid with the second layer 202. In the configuration shown in FIG. 2D, the first layer 201 and the second layer 202 are overlaid in a minimum light-transmissivity configuration which permits no light to be transmitted through the first layer 201 and the second layer 202.

FIG. 2E shows a plan view of the example of the mechanical smart window shown in FIG. 2D, but with the first layer made semi-transparent to allow the second layer to be seen simultaneously with the first layer. The light-blocking areas 212 for the first layer 201 of the mechanical smart window 200 are indicated using a hatched pattern which travels in a SW-NE direction, and the light-blocking areas 212 for the second layer 202 are indicated using a hatched pattern which travels in a SE-NW direction. The area of overlap between the light-blocking areas 212 of the first layer 201 and the second layer 202 is indicated by a hatched pattern which combines the SE-NW direction lines and the SW-NE direction lines to form a diagonal square mesh.

FIG. 2F shows a plan view of the example of the mechanical smart window shown in FIG. 2D, but with the first layer made semi-transparent to allow the second layer to be seen simultaneously, and with the first layer shifted to allow for some light transmission through the layers. More specifically, FIG. 2F shows the first layer 201 of the mechanical smart window 200 shifted to the right by approximately 25% of the width of the base pattern 211. As can be seen, this causes the light-transmitting areas 213 of the first layer 201 and the second layer 202 to be partially unblocked by the light-blocking areas 212 of the second layer 202 and the first layer 201, respectively.

FIG. 2G shows a plan view of the example of the mechanical smart window shown in FIG. 2D, but with the first layer made semi-transparent to allow the second layer to be seen simultaneously with the first layer, and with the first layer shifted with respect to the second layer to allow for maximum light-transmissivity. More specifically, FIG. 2G shows the first layer 201 shifted to the right by approximately 50% of the base pattern 211's width. As can be seen, this causes the light-transmitting areas 213 of the first layer 201 and the second layer 202 to be aligned to the maximum extent possible. In other words, the maximum light-transmissivity state for the mechanical smart window 200 shown in FIGS. 2A-2G is achieved in the configuration shown in FIG. 2G.

Such implementations may provide, for example, several design features. One such feature is that all of the light-blocking areas 212 may be connected into one, contiguous light-blocking area 212. This allows, for example, the first layer 201 to be formed from a single sheet of opaque material from which the light-transmitting areas 213 are removed. In other words, the light-transmitting areas 213 may not be substantially transparent material, but may instead simply be the absence of the material forming the first layer 201. Another feature is that the overlap area may prevent light leakage through the layers due to imperfections in the formation of the light-blocking areas 212 and the light-transmitting areas 213 for each layer, slight misalignments of base patterns, or other anomalies. The third ramification is that light which strikes the layers at an oblique angle will have a lesser chance of seeping through the layers via the gaps between layers.

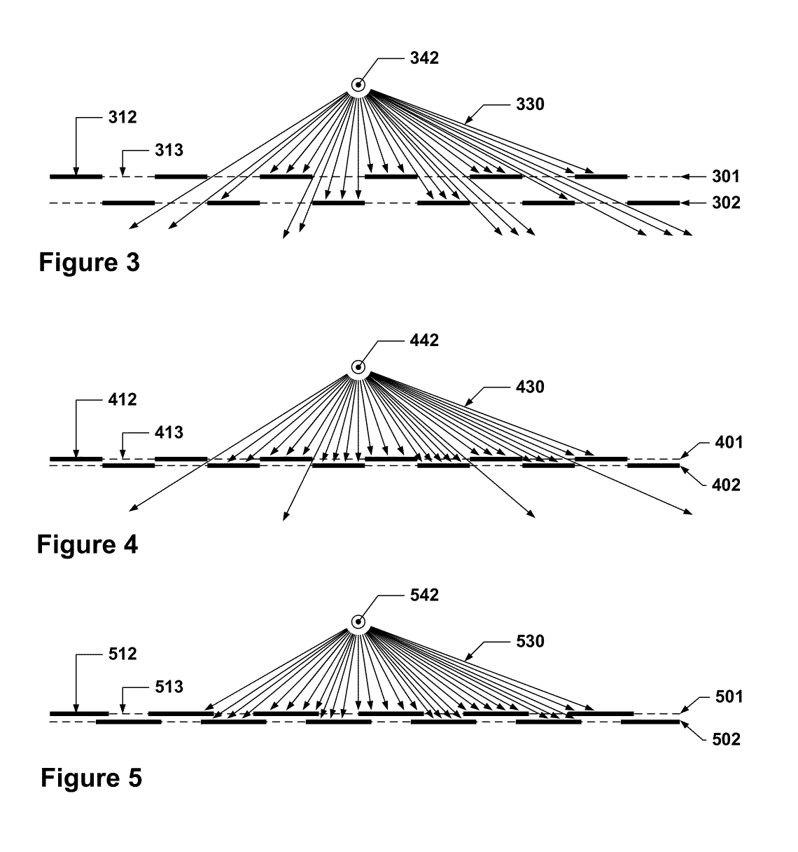

Light seepage may, in general, occur depending on the degree of overlap between light-blocking areas and light-transmitting areas in the minimum light-transmissivity state, as well as the spacing or offset between layers in a direction normal to the layers. FIG. 3 shows a side view of a portion of an example of a mechanical smart window implementation with two layers and equal-sized light-transmitting and light-blocking areas. A first layer 301 and a second layer 302 each have light-blocking areas 312 and light-transmitting areas 313 which are substantially equal in size. The first layer 301 and the second layer 302 may be spaced apart some distance, for example, 50% of the width of the light blocking areas 312. A light source 342 may emit light along light paths 330. Many, but not all, of the light paths 330 which are shown may be blocked by the light-blocking areas 312 on either the first layer 301 or the second layer 302. The unblocked light paths 330 represent light seepage.

FIG. 4 shows a side view of the portion of the example of the mechanical smart window of FIG. 3, but with a reduced gap between the two layers. A first layer 401 and a second layer 402 are identical to the first layer 301 and the second layer 302 in FIG. 3, but are spaced apart approximately 12.5% of the width of the light-blocking areas 412. As a result, fewer light paths 430 from a light source 442 seep through the first layer 401 and the second layer 402.

FIG. 5 shows a side view of a portion of an example of a mechanical smart window implementation with two layers and light-blocking areas which are larger than the light-transmitting areas. The spacing between a first layer 501 and a second layer 502 in FIG. 5 is approximately the same as the spacing used in FIG. 4. Due to the overlap between light-blocking areas 512 and light-transmitting areas 513, however, no light from a light source 542 via light paths 530 seeps through the first layer 501 and the second layer 502.

It is to be understood that the overlaps discussed above may be effectively reversed in order to produce an opposite effect. For example, if the light-blocking areas are smaller than the light-transmitting areas, the light-blocking areas will not be able to overlap each other, although the light-transmitting areas will overlap each other. This will result in increased light seepage. Such configurations will even allow perpendicularly-incident light to pass through the overlap areas between light-transmitting areas. Such an implementation may be used, for example, for mechanical smart window implementations where it is desirable to allow a non-zero amount of perpendicularly-incident light through the mechanical smart window even in the minimum light-transmissivity state.

In FIGS. 1A-1F and 2A-2G, the mechanical smart window implementations shown have been two-layer mechanical smart windows. However, more than two layers may be used to implement mechanical smart windows. As more layers are used to implement a mechanical smart window, greater light-transmissivity tuning ranges may be supported. For example, the maximum amount of light-transmissivity which may be supported in the transmissivity tuning region of a mechanical smart window while still allowing the mechanical smart window to be rendered fully opaque may be determined by the equation 1−(1/N_{Layers}), where N_{Layers}=number of layers in the mechanical smart window. Thus, for a two-layer mechanical smart window, the maximum amount of light-transmissivity which may be supported in the transmissivity tuning region is 50%. For a four-layer mechanical smart window, the maximum amount of light-transmissivity which may be supported in the transmissivity tuning region is 75%. For a nine-layer mechanical smart window, the maximum amount of light-transmissivity which may be supported in the transmissivity tuning region is approximately 89.9%. It is to be understood that these numbers represent maximum theoretical achievable transmissivity—depending on the base patterns chosen, the actual amount of maximum light-transmissivity supported in the transmissivity tuning region of a mechanical smart window may be less than these values.

Another way of expressing the maximum light-transmissivity of a base pattern is through the maximum ratio of light-blocking area to light-transmitting area for a base pattern which may still result in a mechanical smart window with a transmissivity tuning region which may be rendered fully opaque. For a given number of layers, this ratio may be expressed as 1:(N_{Layers}−1), where N_{Layers}=number of layers in the mechanical smart window.

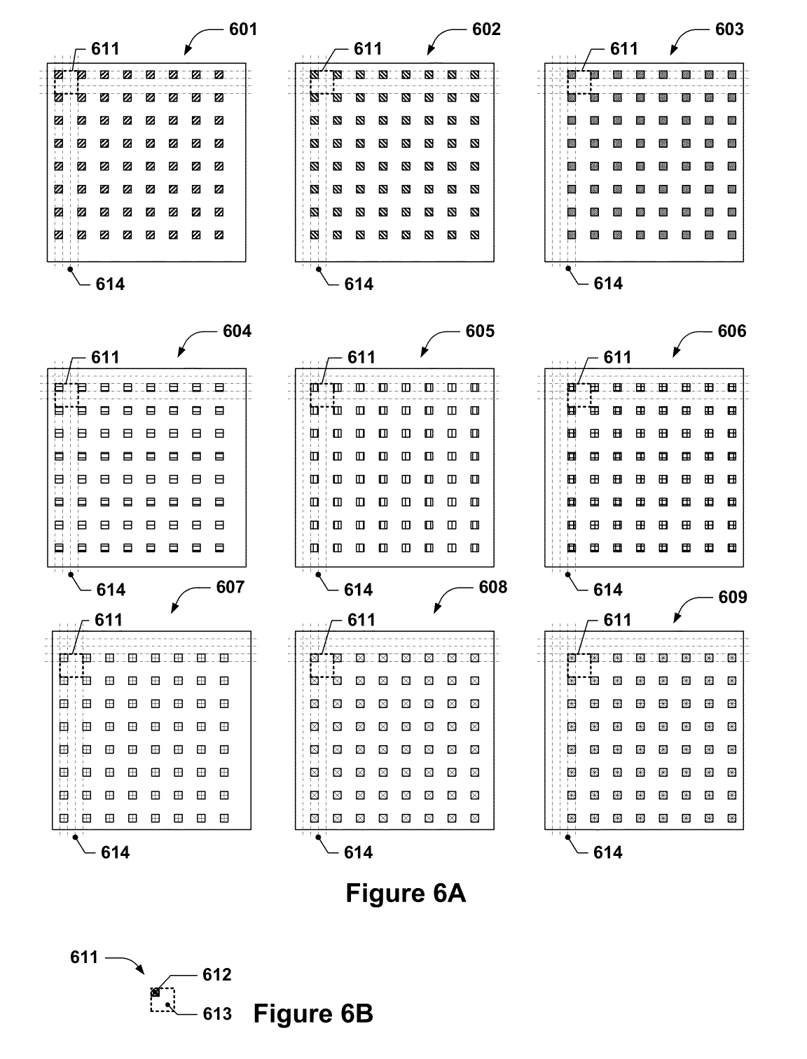

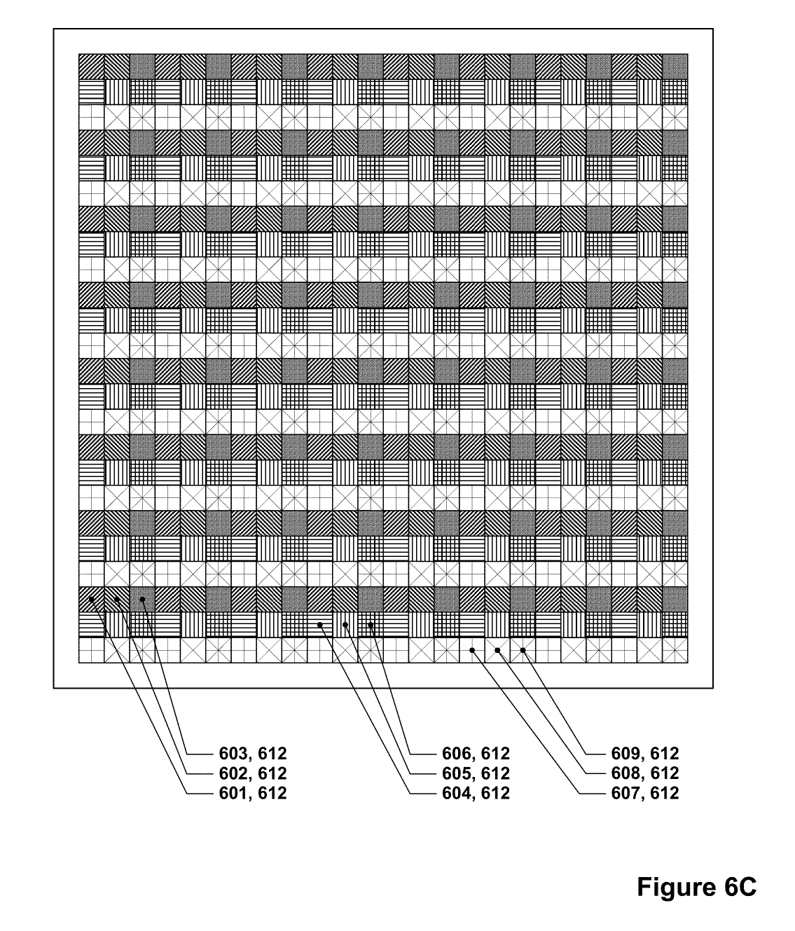

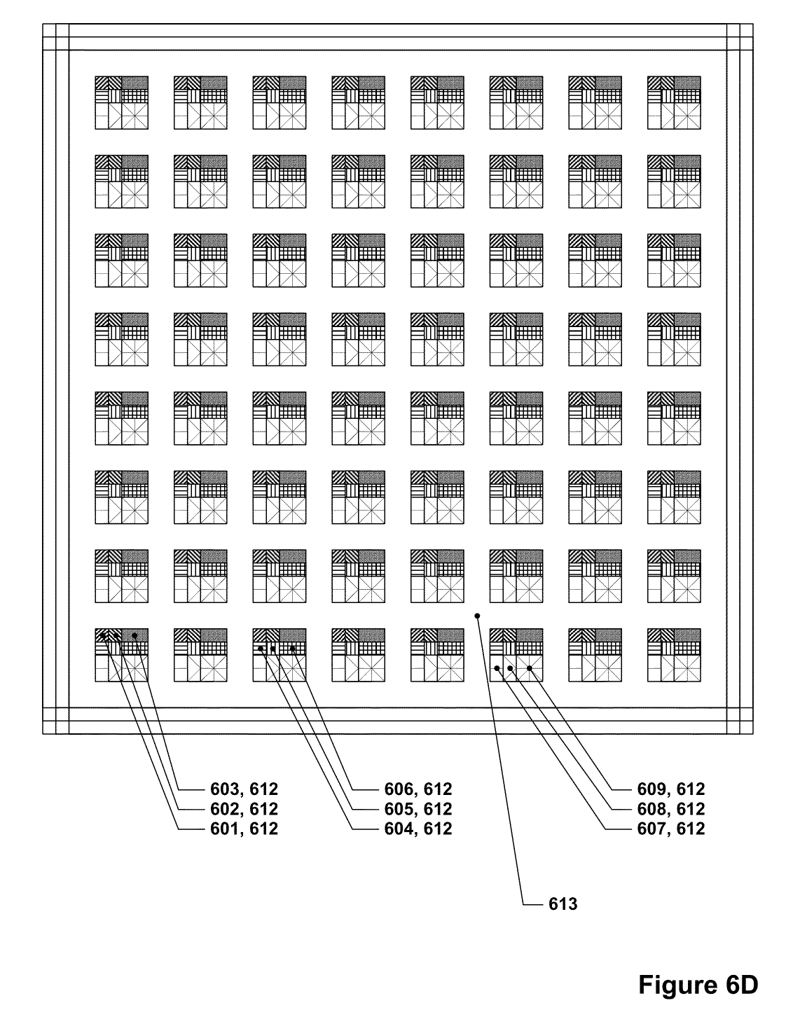

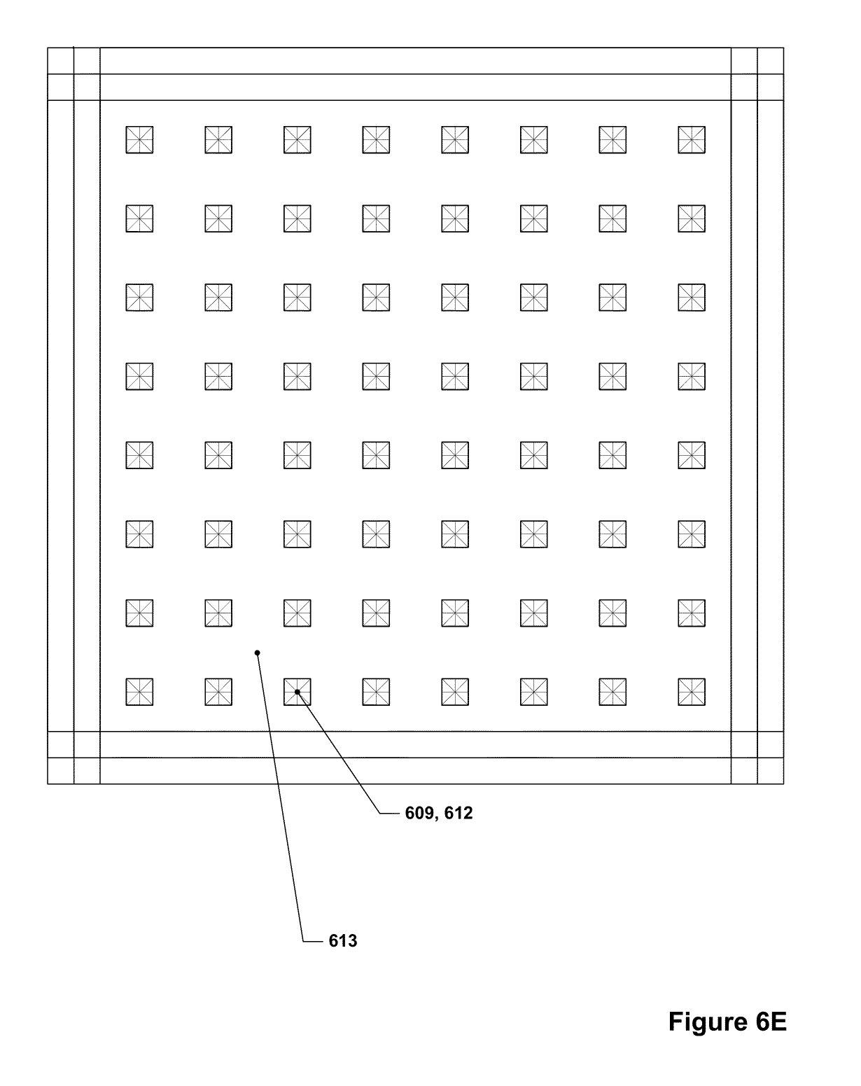

FIGS. 6A-6E show an implementation which may be used to provide a mechanical smart window 600 featuring nine layers. FIG. 6A shows a plan view of examples of layers for use in a mechanical smart window with nine layers. More specifically, FIG. 6A shows a first layer 601, a second layer 602, a third layer 603, a fourth layer 604, a fifth layer 605, a sixth layer 606, a seventh layer 607, an eighth layer 608, and a ninth layer 609. Also shown with respect to each layer is a reference grid 614, which may be used to better visualize the relative locations of a base pattern 611 on each layer. The reference grid 614 is for the reference purposes of the reader and may not actually be a part of any layer depicted. The layers shown in FIGS. 6A-6E feature an 8×8 pattern array of the base pattern 611, although other pattern arrays may be used. On some layers, one or more instances of the base pattern 611 may be split into two or more sections and positioned in different locations on the relevant layer to accommodate shifts of the base pattern 611 between layers.

FIG. 6B shows an example of a base pattern for the layers of FIG. 6A. The base pattern 611 is depicted, including light-transmitting area 613 and light-blocking areas 612. In some implementations, the base patterns 611 along the edge of the pattern array may be partial portions of the base patterns 611 and complementary portions of the base pattern 611 may not be included elsewhere on the layer. In other words, the pattern array may not involve round numbers of instances of the base pattern 611. FIGS. 6C-6E also show the base pattern 611, but the base pattern 611 is not separately called out in these figures. As may be seen from FIG. 6A, the light-transmitting areas 613 from each instance of the base pattern 611 may be contiguous and form a “grid” pattern on each layer, and the light-blocking areas 612 of each instance of the base pattern 612 may form the grid interstices of the grid pattern.

FIG. 6C shows a plan view of an example of a mechanical smart window with nine layers in the minimum light-transmissivity state. As depicted in FIG. 6C, the first layer 601 through the ninth layer 609 are overlaid with each other to form the mechanical smart window 600, with the ninth layer 609 being the topmost layer. As can be seen, in this configuration, the light-transmitting area 613 within the base pattern 611 on each layer is overlaid entirely with the light-blocking areas 612 of the other layers, preventing light from being transmitted through the base patterns 611. For example, one eighth of the light-transmitting area 613 on the ninth layer 609 is overlaid by the light-blocking areas 612 of the first layer 601, another eighth of the light-transmitting area 613 on the ninth layer 609 is overlaid by the light-blocking areas 612 of the second layer 602, and so forth.

FIG. 6D shows a plan view of the example of the mechanical smart window shown in FIG. 6C in moderate light-transmissivity state. More specifically, FIG. 6D shows the second layer 602, the fifth layer 605, and the eighth layer 608 moved ⅙^{th} of the width of the base pattern 611 to the left, and the third layer 603, the sixth layer 606, and the ninth layer 609 moved ⅓^{rd} of the width of the base pattern 611 to the left. In addition to these leftward movements, FIG. 6D also shows the fourth layer 604, the fifth layer 605, and the sixth layer 606 moved upwards ⅙^{th} of the height of the base pattern 611 and the seventh layer 607, the eighth layer 608, and the ninth layer 609 moved upwards ⅓^{rd} of the height of the base pattern 611. In this configuration, approximately 5/9 of each instance of the base pattern 611 transmits light through the light-transmitting areas 613 of each layer.

FIG. 6E shows a plan view of the example of the mechanical smart window shown in FIG. 6C in the maximum light-transmissivity state. More specifically, FIG. 6E shows the second layer 602, the fifth layer 605, and the eighth layer 608 moved ⅓^{rd} of the width of the base pattern 611 to the left, and the third layer 603, the sixth layer 606, and the ninth layer 609 moved ⅔^{rd} of the width of the base pattern 611 to the left. In addition to these leftward movements, FIG. 6D also shows the fourth layer 604, the fifth layer 605, and the sixth layer 606 moved upwards ⅓^{rd} of the height of the base pattern 611 and the seventh layer 607, the eighth layer 608, and the ninth layer 609 moved upwards ⅔^{rd} of the height of the base pattern 611. In this configuration, approximately 8/9 of each instance of the base patterns 611 transmits light through the light-transmitting areas 613 of each layer, which is the maximum light-transmissivity for the base patterns 611 in this implementation.

In mechanical smart windows where the light-blocking area of the base pattern is smaller than the light-transmitting area of the base pattern, a minimum light-transmissivity state may be achieved by partially overlapping a layer's light-transmitting area with corresponding light-blocking areas from several other layers. Each such light-blocking area may block a different portion of the corresponding light-transmitting area. This may allow the light-blocking areas to block more light-transmitting area as a group than individually. In the minimum light-transmissivity state, this may involve the entire light-transmitting area for a layer being completely overlapped by partial overlaps of the corresponding light-blocking areas from other areas.

Other implementations of a mechanical smart window may feature other light-blocking and light-transmitting area shapes. For example, one implementation of a mechanical smart window may have light-blocking areas in the shape of straight, or nearly straight, parallel lines, with each line separated from any neighboring lines by a gap which forms a light-transmitting area, giving the appearance of a grating. Some implementations may feature highly irregular shapes. For example, tessellated patterns of shapes similar to those shown in M. C. Escher's “Birds” (1967), “Pegasus” (1959), or “Scarabs” (1953) tessellation prints may be used.

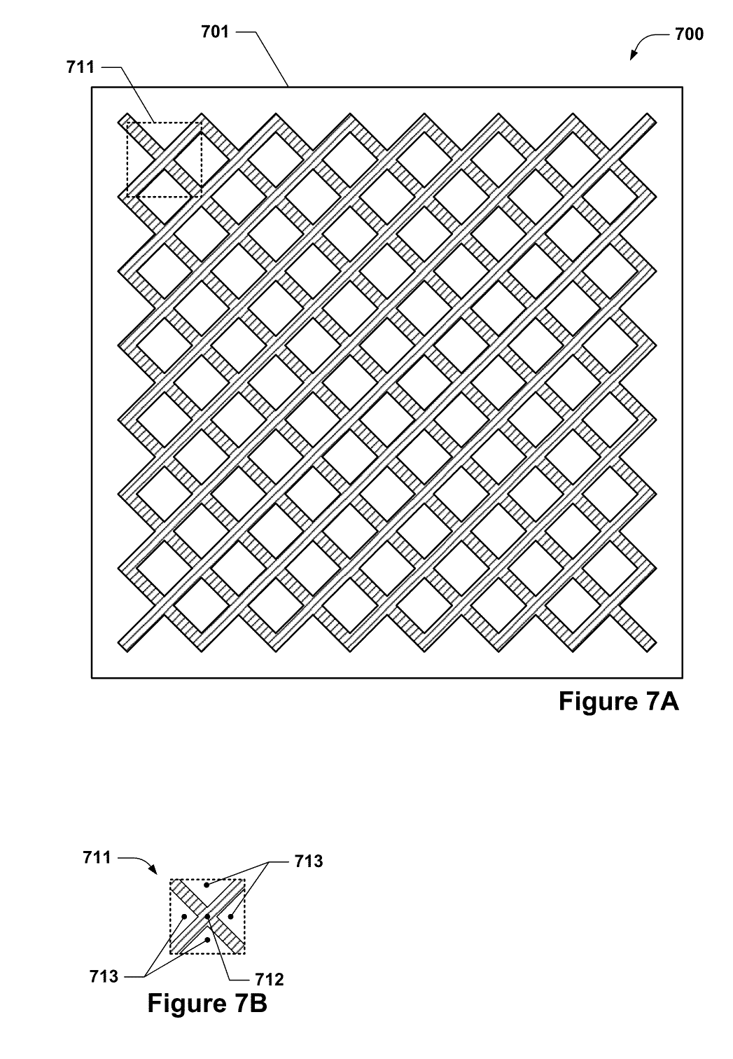

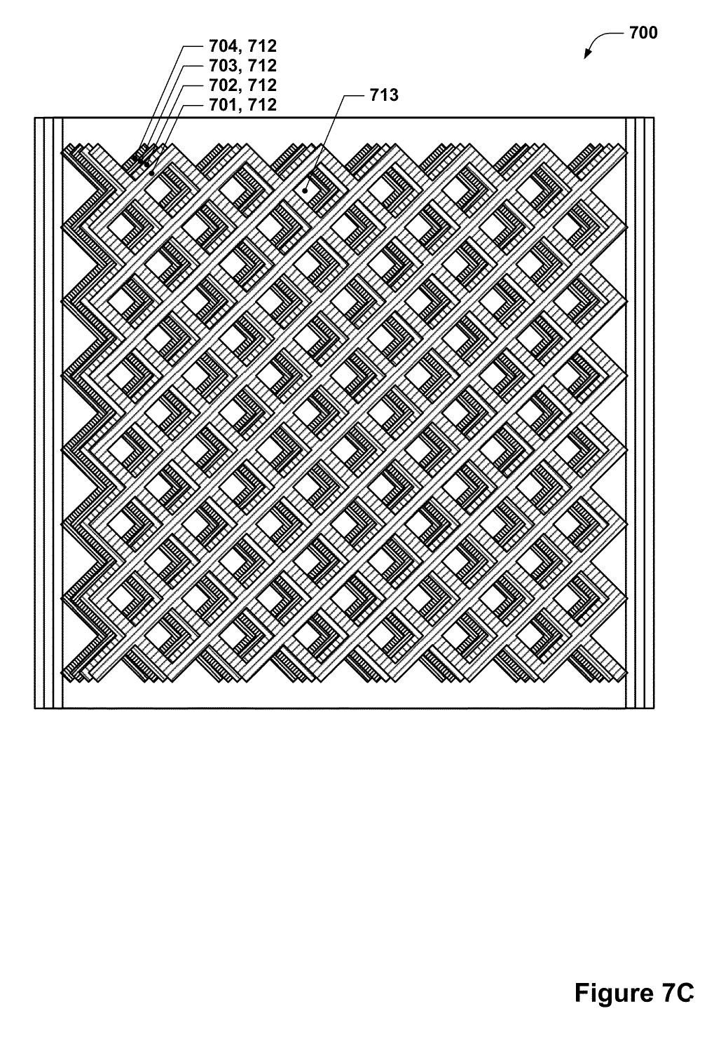

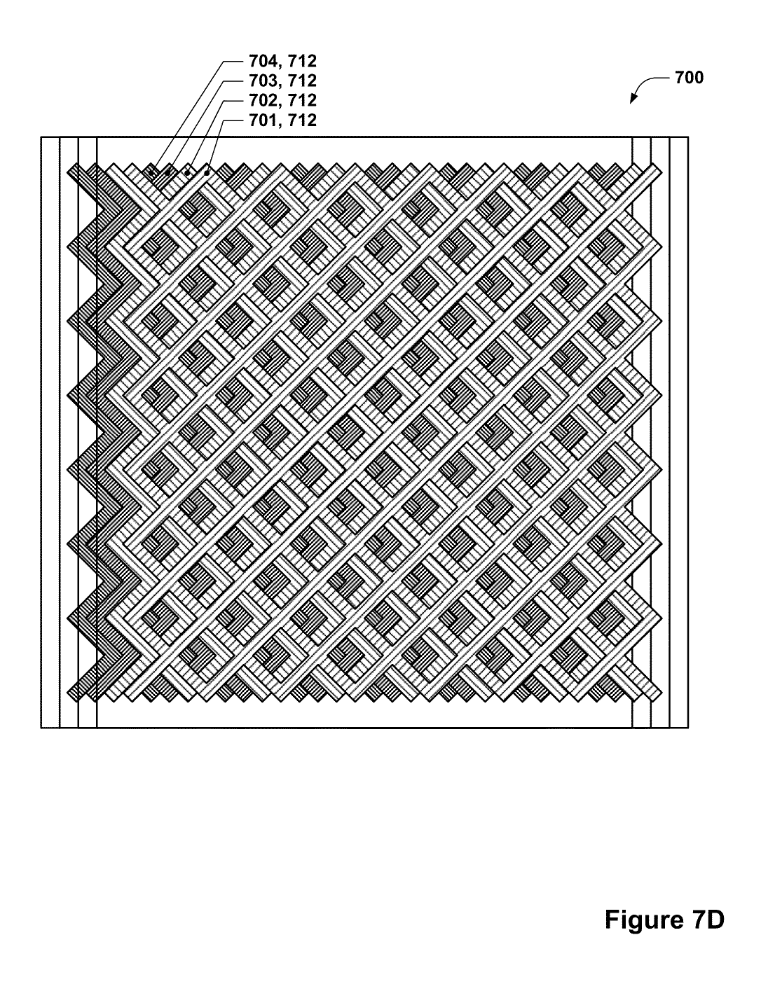

FIGS. 7A-7D, for example, show an example a mechanical smart window 700 with layers including a diagonal grid of light-blocking areas 712. FIG. 7A shows a plan view of an example of a first layer with a diagonal grid pattern for use in a mechanical smart window with four layers. FIG. 7A further shows the mechanical smart window 700 in the maximum light-transmissivity state with the light-blocking areas 712 all aligned. In the maximum light-transmissivity state, only a first layer 701, including a base pattern 711, is visible in FIG. 7A.

FIG. 7B shows an example of a base pattern for the first layer of FIG. 7A. The base pattern 711 includes the light-blocking area 712, which is roughly in the form of an “X.” Light-transmitting areas 713 exist on each side of the light-blocking area 712. The base pattern 711 is arranged in a 7×7 pattern array, although at the perimeter of the pattern array, extra light-blocking areas 712 not part of the base pattern 711 are also included. When instances of the base pattern 711 are patterned as shown in FIG. 7A, the resulting overall pattern may appear to be a grid, oriented at approximately 45° to the direction of layer movement, formed by the light-blocking area 712 with the light-transmitting areas 613 in the grid interstices.

FIG. 7C shows a plan view of an example of a mechanical smart window using the first layer of FIG. 7A and three additional layers; the resulting mechanical smart window with four layers is shown in an intermediate light-transmissivity state. In FIG. 7C, the first layer 701, a second layer 702, a third layer 703, and a fourth layer 704 of the mechanical smart window 700 are shown. In this implementation, the base pattern 711 is not shifted different amounts with respect to the edges of the layers, and each of the first layer 701, the second layer 702, the third layer 703, and the fourth layer 704 are, with respect to placement of the base pattern 711, the same. Thus, when the first layer 701, the second layer 702, the third layer 703, and the fourth layer 704 are arranged in an aligned stack, the light-transmitting areas 713 for each layer align with the light-transmitting areas 713 for the other three layers. In such a configuration, the mechanical smart window 700 would appear similar to the image shown in FIG. 7A. In FIG. 7C, however, the second layer 702, the third layer 703, and the fourth layer 704 have each been shifted relative to the layer immediately above each respective layer by an equal amount to the left. Thus, the second layer 702 has been shifted to the left of the first layer 701 by approximately ⅛^{th} of the width of the base pattern 711. The third layer 703 has been shifted to the left of the second layer 702, and the fourth layer 704 shifted to the left of the third layer 703, by the same amount. This has the effect of blocking approximately 75% of the light-transmitting areas 713 of each instance of the base patterns 711.

FIG. 7D shows a plan view of the example of the mechanical smart window shown in FIG. 7C with the layers shifted to produce the minimum light-transmissivity state. In FIG. 7D, each of the second layer 702, the third layer 703, and the fourth layer 704 have been shifted further with respect to the layer immediately above each respective layer by an equal amount to the left. In FIG. 7D, the second layer 702 has been shifted to the left of the first layer 701 by approximately ¼^{th} of the width of the base pattern 711. The third layer 703 has been shifted to the left of the second layer 702, and the fourth layer 704 shifted to the left of the third layer 703, by the same amount. This has the effect of blocking approximately 100% of the light-transmitting areas 713 of each instance of the base patterns 711.

The discussion thus far has focused on various implementations of layers for mechanical smart windows. The following discussion provides some example implementations of drive mechanisms and support structures which may be used to move or shift mechanical smart window layers with respect to each other. Various technologies may be used. For example, layers may be moved during light transmission tuning using linear actuators, micro-electromechanical devices, such as comb drives, or kinematic linkages which transform rotary motion into linear motion.

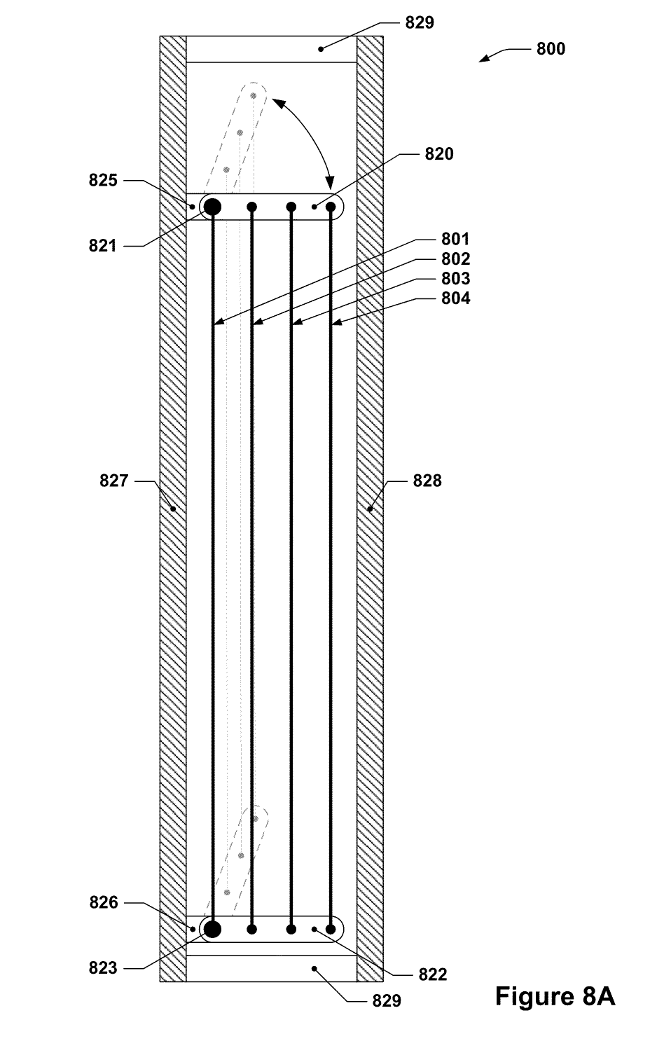

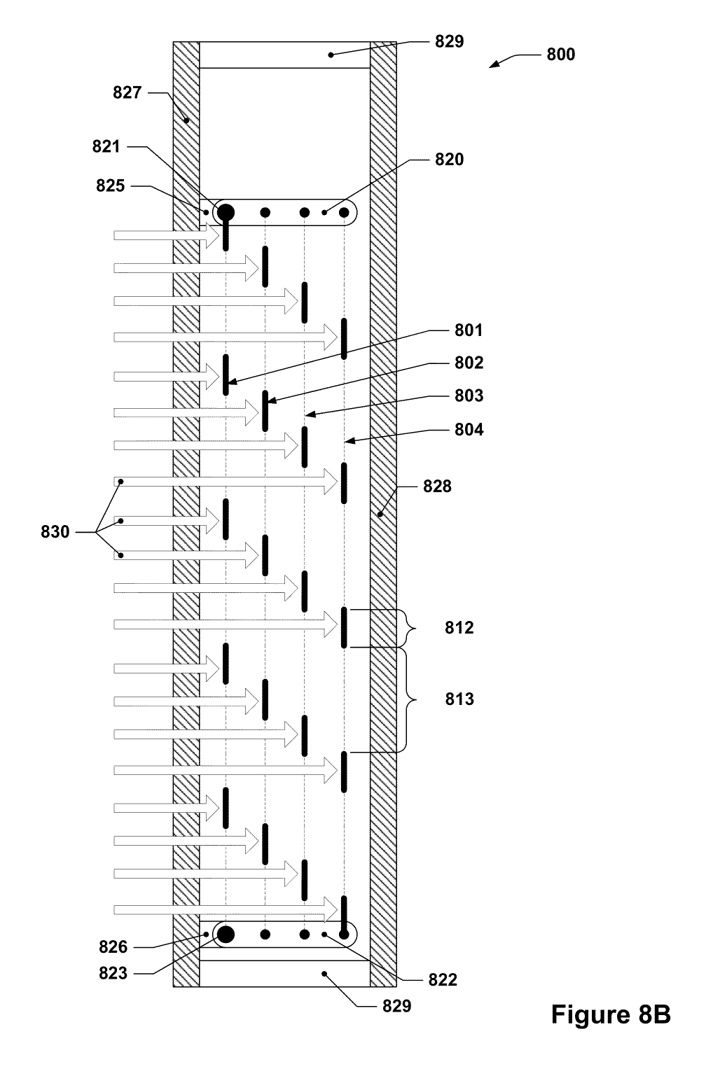

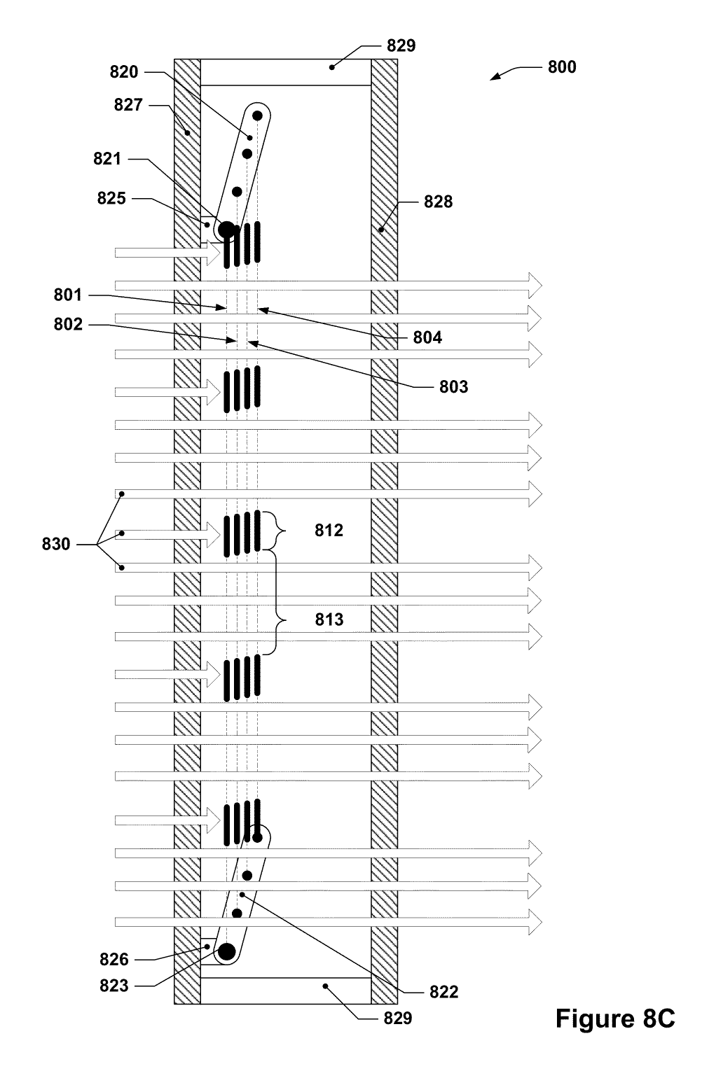

One such mechanism or support structure is shown in FIGS. 8A-8C, which depict a multi-layer mechanical smart window 800 with a parallel link mechanism which may be used, for example, to shift each layer by equal amounts with respect to any neighboring layer or layers.

FIG. 8A shows a side view of an example of a mechanical smart window with a parallel linkage mechanism. As seen in FIG. 8A, a first layer 801, a second layer 802, a third layer 803, and a fourth layer 804 of the mechanical smart window 800 may each be connected in a rotatable manner at one end to a first parallel link 820 and at the other end to a second parallel link 822. The first parallel link 820 may be connected with a first pivot 821 in a rotatable manner, forming a pivot arm. The second parallel link 822 may be connected with a second pivot 823 in a rotatable manner, also forming a pivot arm. When the spacing between adjacent layers in a direction normal to the layers is the same for each layer, the resulting multi-tiered parallel linkage will cause each layer, and each light-blocking area and light-transmitting area on each layer, to simultaneously shift the same amount in a direction parallel to the layer planes with respect to any adjacent layer, and each light-blocking area and light-transmitting area on each adjacent layer, when the linkage is pivoted. It is to be understood that while one layer in the stack of layers may remain motionless, the movement of the remaining layers will still result in all of the layers experiencing movement relative to each other. Such a parallel linkage mechanism may also act to keep the first layer 801, the second layer 802, the third layer 803, and the fourth layer 804 spaced apart and may theoretically prevent the layers from contacting each other in at least one parallel linkage configuration.

FIG. 8A also shows a first transparent surface 827 and a second transparent surface 828, which may be spaced apart by spacers 829 to provide a gap within which the parallel-linkage/layer assembly may be housed. The first pivot 821 and the second pivot 823 may be supported, for example, by the first transparent surface 827 via a first anchor 825 and a second anchor 826, respectively. Other mounting configurations may be implemented as well. For example, the mechanical smart window 800 may be vertically-oriented and it may be sufficient, for example, to support the uppermost parallel link, in this case, the first parallel link 820, and allow the layers to hang in space from the first pivot 821.

In some implementations, one of the layers of a mechanical smart window such as that shown in FIGS. 8A-8C may be integral with a fixed surface, for example, the first transparent surface 827 may include light-blocking areas 812 and light-transmitting areas 813. Thus, the functionality provided by the first layer 801 and the first transparent surface 827 may be provided by a single component rather than two separate components.

FIGS. 8B-8C show the mechanical smart window 800 as shown in FIG. 8A, but with some additional detail for the first layer 801, the second layer 802, the third layer 803, and the fourth layer 804. Specifically, the light-blocking areas 812 and the light-transmitting areas 813 are shown for each layer, as are arrows indicating light paths 830 perpendicularly-incident to the mechanical smart window 800.

In the implementation shown in FIGS. 8A-8C, the first layer 801 is in-plane with the first pivot 821 and the second pivot 823, and thus does not move when the first parallel link 820 and the second parallel link 822 are rotated about the first pivot 821 and the second pivot 823, respectively. The second layer 802, the third layer 803, and the fourth layer 804, however, do move when the first parallel link 820 and the second parallel link 822 are rotated. Specifically, the second layer 802, the third layer 803, and the fourth layer 804 are each shifted in a direction parallel to the layers, and also in a direction normal to the layers.

FIG. 8B shows a side view of the example of the mechanical smart window shown in FIG. 8A in the minimum light-transmissivity state. FIG. 8B further shows light paths 830 perpendicularly-incident to the mechanical smart window 800. With the first parallel link 820 and the second parallel link 822 oriented perpendicular to the first layer 801, the second layer 802, the third layer 803, and the fourth layer 804, the mechanical smart window 800 is placed in a zero light-transmissivity state, at least with respect to the light paths 830. It is to be understood that, depending on the size of the light-blocking areas 812 and the light-transmitting areas 813 and the spacing between layers, varying amounts of obliquely-incident light may pass through the layers even when the layers are placed in a zero-transmissivity state with respect to the light paths 830. Such oblique-light leakage may be mitigated, for example, using the overlap technique discussed with respect to FIGS. 2A-2G or other techniques.

As can be seen in FIG. 8B, all of light paths the 830 striking the first layer 801, the second layer 802, the third layer 803, and the fourth layer 804 are blocked by the light-blocking areas 812.

FIG. 8C shows a side view of the example of the mechanical smart window shown in FIG. 8A in the maximum light-transmissivity state. In FIG. 8C, the first parallel link 820 and the second parallel link 822 have been rotated to be at a small, acute angle with respect to the first layer 801, the second layer 802, the third layer 803, and the fourth layer 804. The second layer 802, the third layer 803, and the fourth layer 804 have, due to the rotation of the first parallel link 820 and the second parallel link 822, been translated in a vertical direction as well as in a direction closer to the first layer 801. As a result, the light-blocking areas 812 for each layer are largely overlaid, as are the light-transmitting areas 813. This allows approximately 75% of the light paths 830 which were blocked, in FIG. 8B, by the light-blocking areas 813 on the second layer 802, the third layer 803, or the fourth layer 804 to pass through the mechanical smart window 800.

In some mechanical smart window implementations, the smart window may consist of a full window, for example, a double glazed window with movable layers contained within, as shown in FIGS. 8A-8C. In some other mechanical smart window implementations, the smart window may take the form of an insertable cassette which includes the movable layers. Such a cassette may be installed in an existing double-pane window solution to transform the double-pane window into a mechanical smart window. Many existing double-pane windows incorporate substantial air gaps between the glazing, for example, 10-20 mm, which may be used to house a cassette with a mechanical smart window layer mechanism.

In some other mechanical smart window implementations, the mechanical smart window may not be enclosed. While there may be benefits to enclosing some mechanical smart windows to keep dust and other microscopic debris from interfering with the operation of the mechanical smart window, some mechanical smart windows may actually feature light-blocking areas and light-transmitting areas which are relatively large and which may function even with significant exposure to dust or dirt. For example, some mechanical smart windows may be used in greenhouses to allow light into the greenhouse during daylight hours using the maximum light transmissivity state, and to retain heat in the evening hours using the minimum light transmissivity state. Such mechanical smart windows may be implemented using light-transmitting areas and light-blocking areas which may range between several millimeters in size to several centimeters in size. In a greenhouse scenario, the view through the mechanical smart window is not terribly important since the beneficiary of the light is a plant, and the only requirement may be that the plant receive a certain amount of light over the course of a day. Unlike with a human, the aesthetic impact of a large-scale base pattern will be completely lost on the plant and thus may not be a significant design driver in such implementations. Other macro-scale mechanical smart windows may be used as well, for example, as part of staging effects in a theater or in outdoor settings such as a football stadium or other venue.

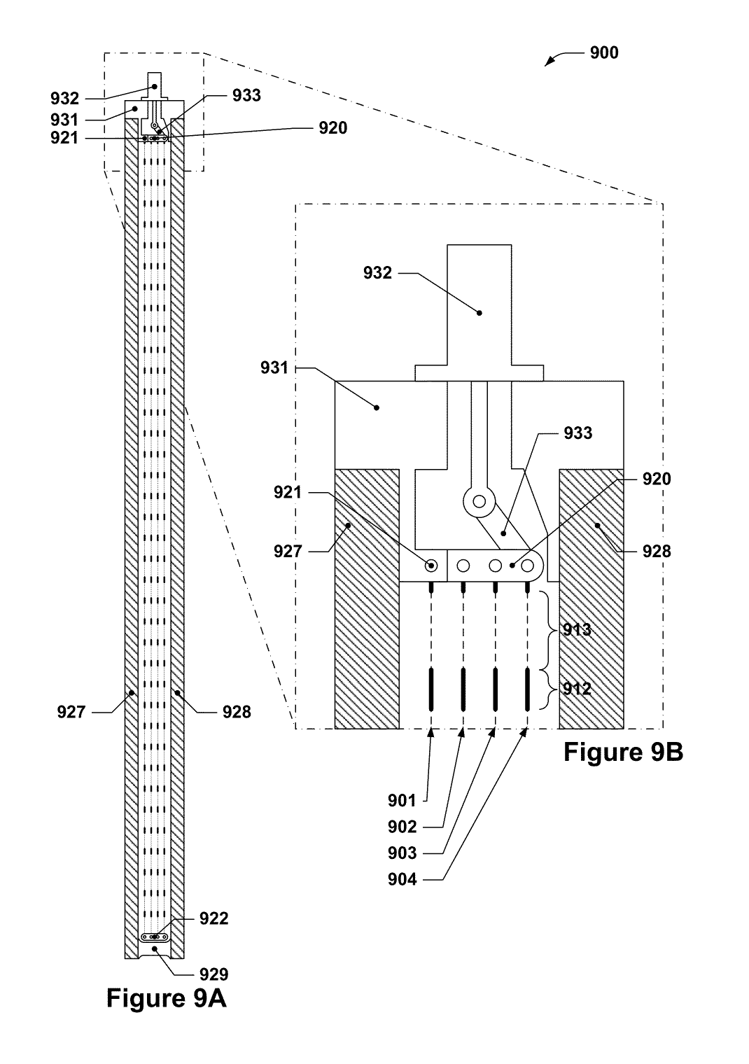

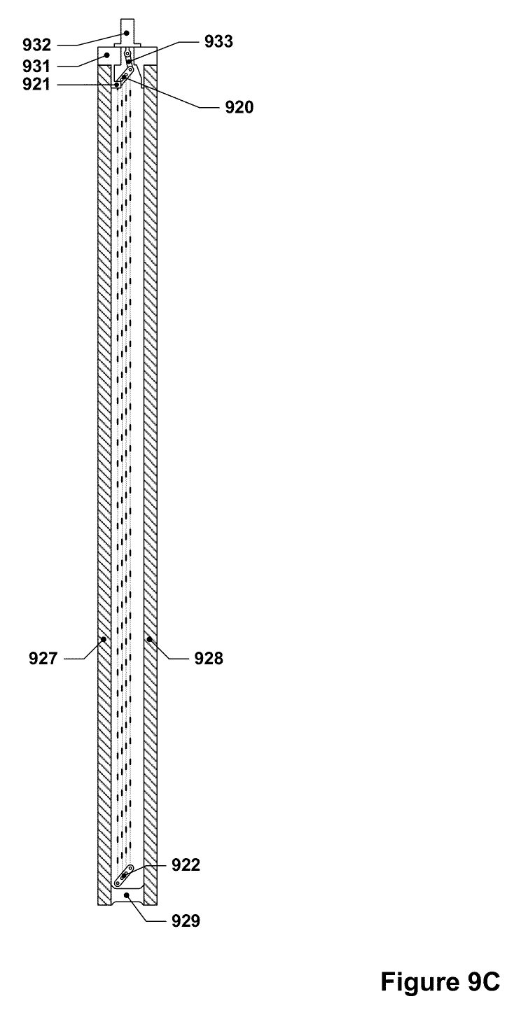

Various mechanisms may be used to cause movement of a parallel linkage as shown in FIGS. 8A-8C. FIGS. 9A-9C show one such mechanism. FIG. 9A shows a side view of an example of a mechanical smart window with four layers, a parallel linkage mechanism, and a linear actuator with the mechanical smart window in the maximum light-transmissivity state. FIG. 9B shows a detail view of a portion of the example of the mechanical smart window shown in FIG. 9A. FIG. 9C shows a side view of the example of the mechanical smart window shown in FIG. 9A with the mechanical smart window in the minimum light-transmissivity state.

In FIG. 9A, a mechanical smart window 900 with a four-layer parallel-linkage is shown. A first layer 901, a second layer 902, a third layer 903, and a fourth layer 904 may be connected with a first parallel link 920 and a second parallel link 922 in a rotatable manner. The first parallel link 920 may be rotatably connected to a feed cap 931 at a first pivot 921, and may also act as a spacer between a first transparent surface 927 and a second transparent surface 928. The second parallel link 922 may not be connected to any structures besides the first layer 901, the second layer 902, the third layer 903, and the fourth layer 904 and may instead simply be suspended in space. In addition to support provided by the feed cap 931, the first transparent surface 927 and the second transparent surface 928 may be additionally supported by a spacer 929.

The first parallel link 920 may be controlled by a control system including a linear actuator 932 and associated power and position controlling hardware and logic. The linear actuator 932 may be rigidly connected with the feed cap 931 and the movable element of the linear actuator 932 may be rotatably connected with a control arm 933. The control arm 933 may also be rotatably connected with the first parallel link 920. The linear actuator 932 may be electrically, hydraulically, or otherwise driven. When the linear actuator 932 is extended, the control arm 933 may cause the first parallel link 920 to be substantially perpendicular to the first layer 901, the second layer 902, the third layer 903, and the fourth layer 904. When the linear actuator 932 is retracted, the control arm 933 may cause the first parallel link 920 to rotate into a position which forms a substantially acute angle with the first layer 901, the second layer 902, the third layer 903, and the fourth layer 904. Such a configuration is shown in FIG. 9C. It is to be understood that the mechanical smart window 900 and the mechanical smart window 800 utilize different patterning of the light-blocking areas 912 and the light-blocking areas 812, respectively, on each layer. For example, light-blocking areas 812 of FIGS. 8A-8C align when first the parallel link 820 and the second parallel link 822 are positioned at an acute angle with respect to the first layer 801, the second layer 802, the third layer 803, and the fourth layer 804. By contrast, the light-blocking areas 912 of FIGS. 9A-9C align when the first parallel link 920 and the second parallel link 922 are positioned at a perpendicular angle with respect to the first layer 901, the second layer 902, the third layer 903, and the fourth layer 904 rather than an acute angle. The positioning of the layers with respect to each other may be adjusted as needed using the linear actuator 932.

In some implementations, the first transparent surface 927, the second transparent surface 928, the spacer 929, and other components (not shown) may form a leak-proof enclosure around the first layer 901, the second layer 902, the third layer 903, and the fourth layer 904. A liquid may then be introduced in between the first transparent surface 927 and the second transparent surface 928. The first layer 901, the second layer 902, the third layer 903, and the fourth layer 904 may be entirely, or nearly entirely, immersed in the liquid. The liquid may act as a lubricant which reduces friction between the layers when the layers are shifted relative to each other in the event that two layers come into contact over the span of the mechanical smart window 900. The liquid may also act to prevent or reduce static charge build-up between the layers, which may further impede movement of the layers with respect to each other. In some implementations, conductive ink may be used to create the light-blocking areas in order to provide an alternate or additional means for discharging any static electricity. The buoyancy of the liquid may also partially “float” the layers, reducing the loading on, for example, the first pivot 921 and reducing the amount of actuation force needed to control, for example, the first parallel link 920.

Such a liquid may be, for example, oil with a high refractive index, such as immersion oil used for optical microscopy. Such oils may be optically transparent and have a refractive index close or identical to that of glass. Such refractive index matching may reduce the amount of light transmission loss due to transitions between materials of differing refractive indices. Such refractive index matching may also act to reduce the amount of oblique light which may seep between layers in a mechanical smart window. For example, if the first transparent surface 927 and the second transparent surface 928 are both made of glass and have a refractive index of 1.5, a light ray in free air which is incident on the first transparent surface 927 of the mechanical smart window 900 at an angle of 45 degrees off-normal with respect to the first transparent surface 927 will experience an angular shift in propagation direction and be approximately 28 degrees off-normal with respect to the first transparent surface 927 when travelling through the first transparent surface 927. If the mechanical smart window 900 is air-filled between the first transparent surface 927 and the second transparent surface 928, the light ray will experience another shift in propagation direction when it exits the first transparent surface 927 and enters the air gap between the first transparent surface 927 and the second transparent surface 928. This second propagation direction shift results in the light ray retuning to a direction 45 degrees off-normal with respect to the first transparent surface 927. However, if the mechanical smart window 900 is filled, for example, with immersion oil with a refractive index which is also 1.5, the propagation direction will remain at 28 degrees off-normal with respect to the first transparent surface 927 upon exiting the first transparent surface 927. The closer light rays are to perpendicular with respect to the mechanical smart window 900 when passing through the mechanical smart window 900, the less light seepage will occur through interlayer gaps in the vicinity of transitions between the light-blocking areas 912 and the light-transmitting areas 913.

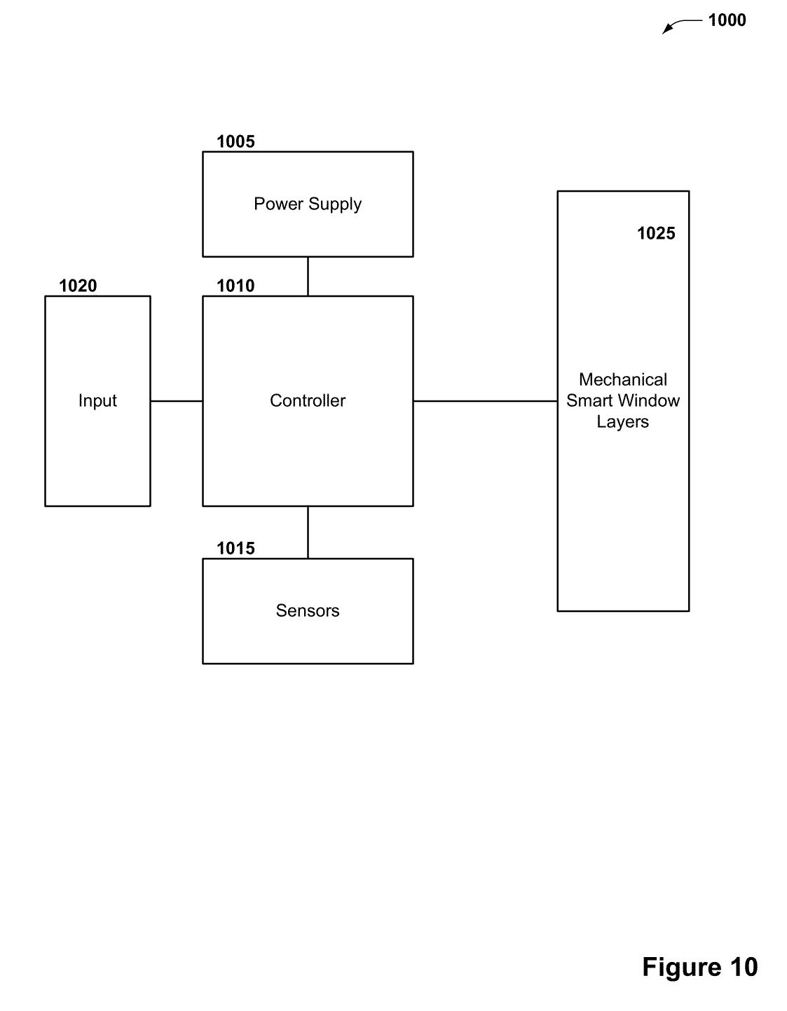

FIG. 10 shows a high-level block diagram of an example of a mechanical smart window system. A mechanical smart window system 1000 may include a power supply 1005, a controller 1010, one or more inputs 1015, and one or more sensors 1020. The mechanical smart window system 1000 may also include two or more mechanical smart window layers 1025, such as those shown in FIG. 1A-1F, 2A-2G, 6A-6E, 7A-7D, 8A-8C, or 9A-9C.

The power supply 1005 may supply power to the controller 1010. The controller 1010 may include one or more logic devices as well as one or more actuators and/or mechanisms configured to move the mechanical smart window layers 1025. The actuators may, for example, be similar to the linear actuator 932 of FIGS. 9A-9C. The mechanisms may, for example, be similar to the parallel linkage shown in FIGS. 8A-8C.

The controller 1010 may also be configured to communicate with the one or more inputs 1015, which may be configured to receive input from an operator indicating into which light-transmissivity state the mechanical smart window system 1000 should be placed. The input 1015 may allow an operator to specify a light-transmissivity state anywhere in the range of light-transmissivity states supported by the mechanical smart window system 1000.

The controller 1010 may also be configured to communicate with the one or more sensors 1020, which may be configured to provide feedback regarding environmental conditions which may determine the light-transmissivity state of the mechanical smart window system 1000. For example, light sensors may be used to measure the amount of illumination present in a room with the mechanical smart window system 1000. If the amount of light measured by the light sensors drops below a specified threshold, the controller 1010 may be configured to move the mechanical smart window layers 1025 to allow for greater light transmissivity into the room.

The controller 1010 may be a programmable device, or an application-specific circuit. For example, the controller 1010 may be an embedded computer and may be capable of communicating with other controllers 1010 of other mechanical smart window systems 1000 to provide coordinated light transmissivity adjustment across multiple mechanical smart window systems 1000.

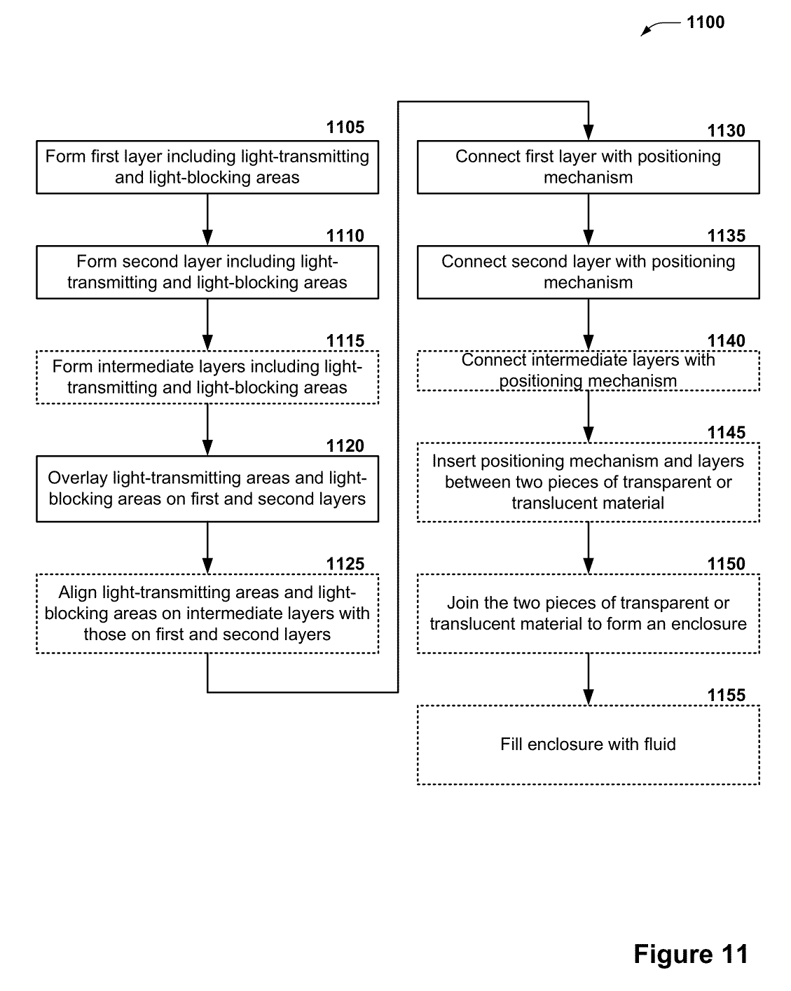

FIG. 11 shows a flow diagram for an example of an implementation of a manufacturing technique for producing some mechanical smart windows according to this disclosure. In block 1105, a first layer including light-transmitting and light-blocking areas is produced. As discussed above, such a layer may be produced from a light-transmitting transparent or translucent material, and then light-blocking areas may be printed or otherwise deposited thereon. Alternatively, such a layer may be an opaque layer, and portions of the layer may be removed to form light-transmitting areas. Any of a variety of different layer materials and manufacturing techniques may be used, as discussed previously.

In block 1110, a second layer including light-transmitting and light-blocking areas is produced. The second layer may be produced in much the same manner as the first layer. In some implementations, however, the second layer may be produced in at least a slightly different manner. For example, in implementations where one of the layers is integrated with a substantially transparent material, for example, one of the pieces of substantially transparent material from block 1145, a different manufacturing process may be used to accommodate differences in size, shape, or material between the two layers.

In optional block 1115, one or more intermediate layers may be produced. Block 1115 may be performed when the mechanical smart window being produced features more than two layers. A similar manufacturing process as that used to produce the first and second layers, or one of the first and second layers, may be used. Block 1115 may not be performed for two-layer mechanical smart windows.

In block 1120, the light-transmitting areas and light-blocking areas on the layers produced in blocks 1105-1015 are aligned with each other. While the layers of a mechanical smart window may move and shift during normal operation, depending on the implementation, there may still be alignment which may be performed during manufacturing. For example, for a parallel linkage, multi-layer smart window as shown in FIGS. 9A and 9C, the light-blocking areas 912 and the light-transmitting areas 913 may need to be aligned in a direction perpendicular to the shift/movement direction. There may also need to be alignment of the layers to ensure that the light-blocking areas on each layer overlay each other in the maximum light-transmissivity state and that the light-transmitting areas are overlaid by light-blocking areas in the minimum light-transmissivity state.

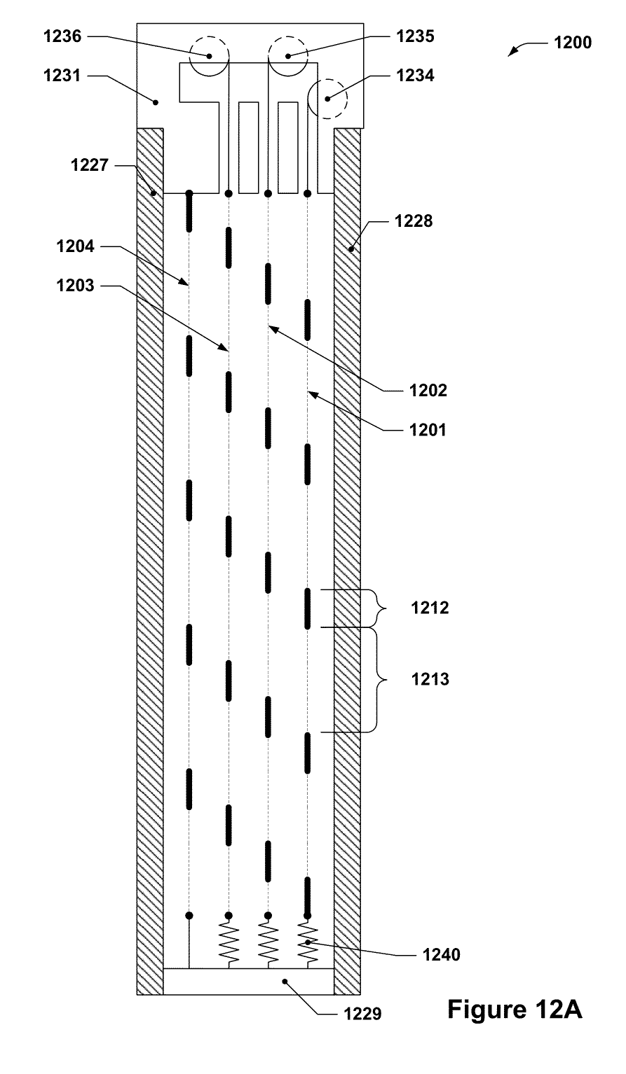

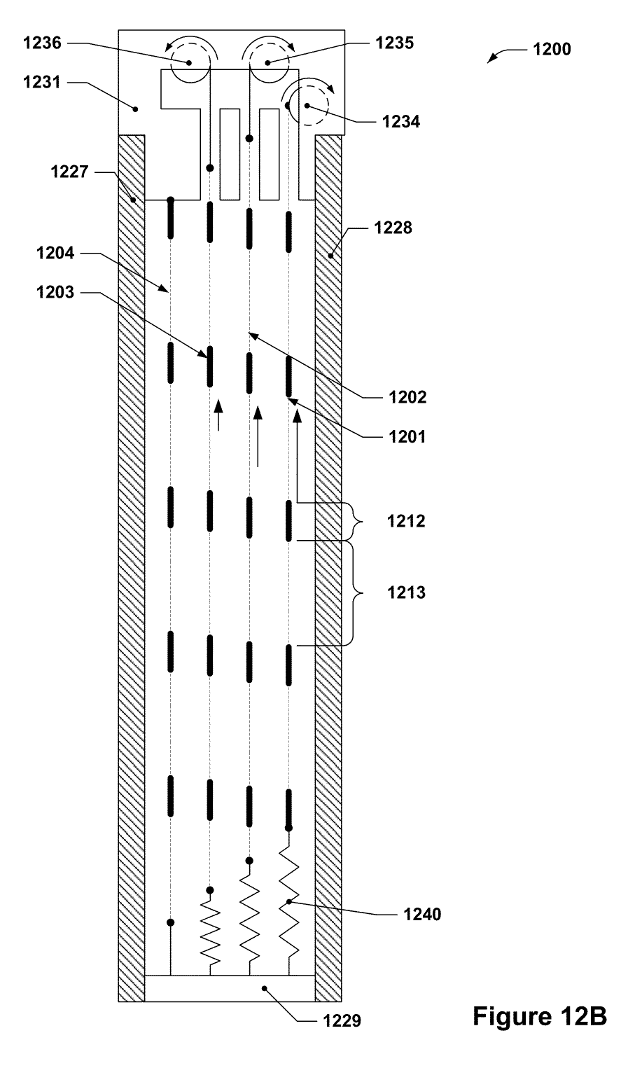

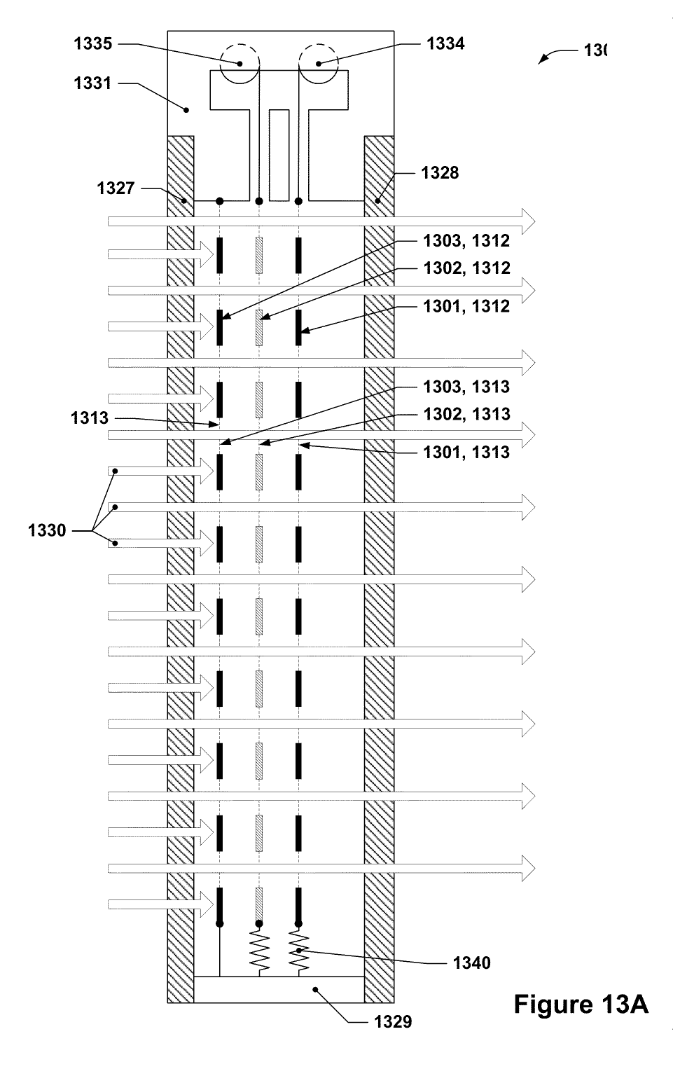

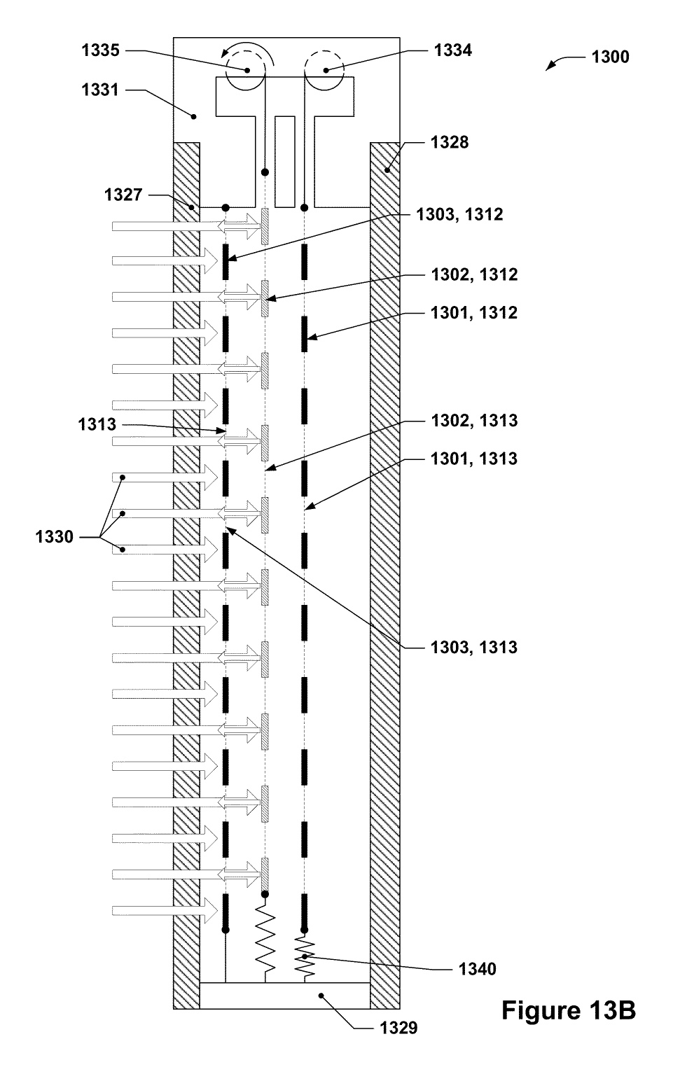

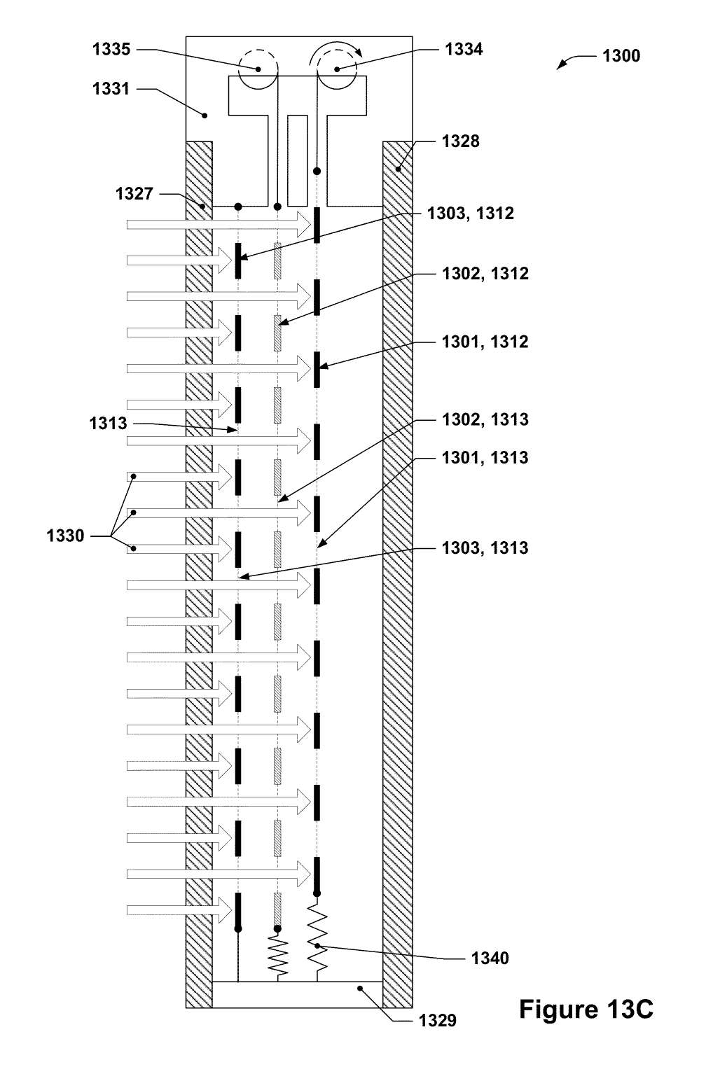

In block 1125, alignment similar to that performed in 1120 may be performed with respect to intermediate layers, if any. In block 1130, the first layer may be connected with a positioning mechanism such as, for example, the parallel linkage shown in FIGS. 8A-8C or FIGS. 9A and 9C, or the spool-drive mechanism shown in FIGS. 12A and 12B or FIGS. 13A-13C, or may be another mechanism configured to move or shift the layers relative to each other.

In block 1135, the second layer may be connected with the positioning mechanism. In block 1140, any intermediate layers present may also be connected with the positioning mechanism.

In block 1145, the positioning mechanism and connected layers may be optionally inserted between two transparent or translucent pieces of material. For example, the positioning mechanism and connected layers may be inserted into the air gap between the glazing in a double-glazed window. The positioning mechanism may be connected with one or both of the pieces of transparent or translucent material in this block.

In block 1150, the two pieces of transparent or translucent material may be optionally joined together to form an enclosure. For example, two pieces of glass may be sealed together using some form of elastomeric material which both spaces the pieces apart and bonds them together. In some implementations, a spacer may be inserted between the pieces of glass to maintain a desired level of separation.

In block 1155, the resulting enclosure may be filled with a fluid, for example, an immersion oil or a fluid with a refractive index matching or nearly matching that of the pieces of transparent or translucent material. The enclosure may be sealed to prevent fluid escape after the fluid is introduced.

Other manufacturing techniques may be used as well, and fewer or more blocks may be utilized. It is to be recognized that the technique outlined in FIG. 11 need not be performed in the order shown, and that various other orderings of blocks may be used.

Another mechanism which may be used in some implementations is a drive system in which the position of each layer with respect to the other layers may be controlled using, for example, spools. FIGS. 12A and 12B depict one such implementation for a four-layer mechanical smart window 1200. A first layer 1201, a second layer 1202, a third layer 1203, and a fourth layer 1204 may be sandwiched between a first transparent surface 1227 and a second transparent surface 1228, which may be spaced apart by a spacer 1229 and a feed cap 1231. Each layer has light-blocking areas 1212 and light-transmitting areas 1213. Whereas a parallel-linkage mechanism such as that shown in FIGS. 8A-8C, 9A, and 9C may cause the layers to simultaneously translate in a second direction, for example, in a direction normal to the layers, when layers are shifted in a first direction, for example, parallel to the layer planes, other mechanisms, such as that shown in FIGS. 12A and 12B, may allow the layers to be shifted in one direction without any simultaneous translation in any other direction.

FIG. 12A shows a side view of an example of a mechanical smart window with four layers and a spool drive mechanism in the minimum light-transmissivity state. The first layer 1201, the second layer 1202, and the third layer 1203 may each be connected to a first spool 1234, a second spool 1235, and a third spool 1236, respectively, by flexible, non-elastic material capable of being wound around the spools. The opposite ends of the first layer 1201, the second layer 1202, and the third layer 1203, may be connected with the spacer 1229 via elastic connections 1240, for example, via springs. In some implementations, no connection, elastic or otherwise, may connect the first layer 1201, the second layer 1202, and the third layer 1203 to the spacer 1229. Instead, the first layer 1201, the second layer 1202, and the third layer 1203 may be placed in a desired state of tension gravitationally, for example, using the layers' own dead weight or an additional counterweight. In FIG. 12A, each of the light-transmitting areas 1213 on a layer is overlaid by one of the light-blocking areas 1212 on the other layers.

FIG. 12B shows a side view of the example of the mechanical smart window shown in FIG. 12A in the maximum light-transmissivity state. The first spool 1234, the second spool 1235, and the third spool 1236 may be driven to allow for positioning of the first layer 1201, the second layer 1202, and the third layer 1203, respectively, as shown in FIG. 12B. In some implementations, the first spool 1234, the second spool 1235, and the third spool 1236 may be driven by a common drive train—in such implementations, however, the drive train may need to be configured to, for example, rotate the first spool 1234 three times, and the second spool 1235 two times, the amount that the third spool 1236 is rotated (assuming that each spool is of the same diameter). In some implementations, each spool and associated layer may be driven independently, allowing for each layer to be positioned independently of the other layers. In FIG. 12B, each of the light-blocking areas 1212 on a layer is overlaid by one of the light-blocking areas 1212 on the other layers, allowing for maximum light transmission.

In some implementations, it may be desirable to provide a mechanical smart window that provides light-blocking areas which are colored on one or both sides, for example, to match a particular décor or for thermal management reasons. For example, the layers in a mechanical smart window may be produced with a color tone which complements an interior decorating color scheme. Some implementations of mechanical smart windows may include light-blocking areas with a broad-spectrum, high-specularity material, for example, mirrors or other highly-reflective surfaces or coatings. Such mirror-like mechanical smart windows may be used on the exteriors of buildings. In such mirror-like, exterior-mount implementations, the amount of light which is transmitted through the mechanical smart window may be tuned by moving the various layers with respect to each other. However, with mirror-like light-blocking areas, most of the blocked light is reflected away from the mechanical smart window, which reduces the amount of heat energy from the light which is transferred into the mechanical smart window and, consequently, the building via absorption. Conversely, if it is instead desired to increase the amount of heat energy which is transferred into the light-blocking areas of a mechanical smart window through absorption, low-reflectivity, light-absorbing material may be used, such as a matte black material or non-reflective coating.

Opposing sides of the layers in a mechanical smart window may have different colors and/or reflective properties. For example, for a mechanical smart window mounted in the exterior of a building, the sides of the light-blocking areas facing the interior of the building may feature a white pigment to diffusely reflect artificial light from inside the building and provide additional illumination when natural light from outside the building is blocked by the light-blocking areas. At the same time, the sides of the light-blocking areas facing the exterior of the building may feature a matte black pigment to increase the amount of heat which is retained by the building via the mechanical smart window. Various materials with different optical properties may be used for both sides of the light-blocking areas, depending on the light-absorbing/light-reflecting behaviors needed on either side of the mechanical smart window.

For example, in some two-layer mechanical smart window implementations, the light-blocking areas facing a primary source of illumination may be coated with a reflective coating to reflect light away from the mechanical smart window. However, oblique light may seep through such a mechanical smart window by, for example, reflecting off of a light-source-facing, light-blocking area of the layer furthest from the primary source of illumination, onto a light-source-opposing, light-blocking area of the layer closest to the primary source of illumination, and then reflecting off of the light-source-opposing, light-blocking area of the layer closest to the primary source of illumination and passing through a light-transmitting area of the layer furthest from the primary source of illumination. If the light-source-opposing side of the light-blocking areas is coated with a light-absorptive coating, such internal reflections may be significantly reduced, decreasing the amount of oblique light seepage.

In the above example, it is to be understood that the terms “light-source-facing” and “light-source-opposing” are used with reference to the primary source of illumination. Other light sources may be present as well on one or both sides of the mechanical smart window, but these may be considered to be “secondary” sources of illumination. It is also to be understood that while the above example is for a two-layer mechanical smart window, the above-described concept may also be applied to mechanical smart windows with more than two layers.

In some implementations, the light-blocking areas may only block certain types of light, but allow other types of light to be transmitted through the light-blocking areas. For example, a mechanical smart window may be configured, in the minimum light-transmissivity state, to allow visible light from a portion of the visible light spectrum, e.g., yellow light, to be transmitted through the mechanical smart window while blocking light from other portions, e.g., red, orange, green, blue, indigo, violet, etc., of the visible light spectrum. Such a mechanical smart window may be implemented using light-blocking areas formed on a transparent substrate which is coated with a light-filtering optical coating in the light-blocking areas. In some implementations, the substrate itself may be made from a translucent material with light-filtering capabilities, and substrate may be removed in the light-transmitting areas.

Such light-filtering implementations may not be limited to filtering visible light. For example, a mechanical smart window may feature light-blocking areas which are substantially transparent to light in the visible spectrum, but which substantially block or reflect light in the ultraviolet or infrared spectrum. Such a mechanical smart window may be substantially visually transparent to users, but may be used to control the amount of solar heat, e.g., infrared light, which enters a building through the mechanical smart window. For example, a two-layer mechanical smart window which features light-blocking areas which are substantially transparent to visible light but which substantially block infrared light may be used to tune the amount of infrared light which enters through the mechanical smart window from 0% to 50%. In the winter, the mechanical smart window may be set to the maximum infrared light-transmissivity state to allow for solar heating through the mechanical smart window. In the summer, the mechanical smart window may be set to the minimum infrared light-transmissivity state to minimize solar heating through the mechanical smart window. In both states, visibility through the window in the visible light spectrum may be substantially unimpeded. Such a mechanical smart window may be implemented by applying, for example, a dielectric multi-layer coating to a transparent substrate in the light-blocking areas. An example dielectric multi-layer coating is described in U.S. patent application Ser. No. 12/066,738, and may be largely transparent to visible light but also be highly reflective of infrared light.

In some implementations, different layers in a mechanical smart window may have different light reflective/light absorptive properties on the same sides of the light-blocking areas for two or more layers. One such mechanical smart window implementation, mechanical smart window 1300, is illustrated in FIGS. 13A-13C, and includes a first layer 1301, a second layer 1302, and a third layer 1303. The first layer 1301 and the second layer 1302 may be connected with a first spool 1334 and a second spool 1335, respectively, on a feed cap 1331. The first spool 1334 and the second spool 1335 in FIGS. 13A-13C may each be independently driven to allow only one layer of the first layer 1301 and the second layer 1302 to be moved at a time. The first layer 1301 and the second layer 1302 may also be connected to the spacer 1329 via an elastic material or other tensioning element 1340. The third layer 1303 may be fixed in place with respect to the feed cap 1331 and the spacer 1329. The feed cap 1331 and the spacer 1329 may space apart a first transparent surface 1327 and a second transparent surface 1328 such that the first layer 1301, the second layer 1302, and the third layer 1303 are contained between the first transparent surface 1327 and the second transparent surface 1328.

The first layer 1301 may include light-blocking areas 1312 with a non-reflective surface, for example, matte black pigment. The second layer 1302, by contrast, may include light-blocking areas 1312 with a highly-reflective surface, for example, a mirror or mirror-like coating. The third layer 1303 may include light-blocking areas 1312 with optical properties similar to the optical properties of the light-blocking areas 1312 of the first layer 1301 or the second layer 1302. The third layer 1303 may alternatively have light-blocking areas 1312 with optical properties which are different from the optical properties of the light-blocking areas 1312 of both the first layer 1301 and the second layer 1302. In FIGS. 13A-13C, the third layer 1303 is shown with light-blocking areas 1312 with optical properties similar to the optical properties of the light-blocking areas 1312 of the first layer 1301, such as, in this example, a non-reflective surface such as matte black pigment.

In FIGS. 13A-13C, light-blocking areas and light-transmitting areas are sized and spaced relative to each other as they would be in a two-layer mechanical smart window implementation. Thus, the minimum light-transmissivity state in this implementation may be achieved using only two of the three layers.

FIG. 13A shows a side view of an example of a mechanical smart window with three layers and a spool drive mechanism with the mechanical smart window in the maximum light-transmissivity state. In FIG. 13A, the light-blocking areas 1312 of the first layer 1301, the second layer 1302, and the third layer 1303 are aligned and allow approximately 50% of the perpendicularly-incident light paths 1330 striking the layers to pass through the light-transmitting areas 1313 of the layer stack.

FIG. 13B shows a side view of the example of the mechanical smart window shown in FIG. 13A with the mechanical smart window in a reflective minimum light-transmissivity state. In FIG. 13B, the second layer 1302 has been shifted upwards relative to the configuration shown in FIG. 13A by rotating the second spool 1335 counterclockwise, causing the light-blocking areas 1312 on the second layer 1302 to align with the light-transmitting areas 1313 on the first layer 1301 and the third layer 1303. In this configuration, all of the perpendicularly-incident light paths 1330 striking the layers are blocked by the light-blocking areas 1312 on the second layer 1302 or the third layer 1303. Light from the perpendicularly-incident light paths 1330 which is blocked by the third layer 1303 may be diffusely reflected or largely absorbed by the non-reflective surfaces presented by the light-blocking areas 1312 on the third layer 1303. Light from the perpendicularly-incident light paths 1330 which is blocked by the second layer 1302 may, in contrast, largely be reflected away from the second layer 1302 by the highly-reflective surfaces of the light-blocking areas 1312 of the second layer 1302.

FIG. 13C shows a side view of the example of the mechanical smart window shown in FIG. 13A with the mechanical smart window in an absorptive minimum light-transmissivity state. In FIG. 13C, the first layer 1301 has been shifted upwards relative to the configuration shown in FIG. 13A by rotating the first spool 1334 clockwise, causing the light-blocking areas 1312 on the first layer 1301 to align with the light-transmitting areas 1313 on the second layer 1302 and the third layer 1303. In this configuration, all of the perpendicularly-incident light paths 1330 striking the layers are blocked by the light-blocking areas 1312 on the first layer 1301 and the third layer 1303. Light from the perpendicularly-incident light paths 1330 which is blocked by the first layer 1301 and the third layer 1303 may be diffusely reflected or largely absorbed by the non-reflective surfaces presented by the light-blocking areas 1312 on the first layer 1301 or the third layer 1303.

In other variants of such an implementation, a mechanical smart window may include multiple sets of layers, where each set is movable independently of the other sets. For example, a mechanical smart window may include seven layers forming three 3-layer sets; each of the three sets may share one common layer which is the same between all three sets. While the light-blocking areas for the common layer would have the same optical properties for all three layer sets, the light-blocking areas on the remaining two layers for each set may be individually selected. For example, in the seven-layer example discussed above, the first set (and common layer) may feature light-blocking areas which are matte black. When the mechanical smart window is placed into a minimum light-transmissivity state using only the first set of layers, the colored face of the mechanical smart window may appear to be completely matte black. The second set layers, with the exception of the common layer, may feature light-blocking areas which are blue, and the second set layers with the exception of the common layer, may feature light-blocking areas which are yellow. When the mechanical smart window is placed into a minimum light-transmissivity state using only the second set of layers, the colored face of the mechanical smart window may appear to be a dark shade of blue due to the mixture of the matte black light-blocking areas on the common layer with the blue-colored light-blocking areas on the other layers of the second set. In other words, approximately 33% of the light-blocking areas visible to an observer are matte black, and approximately 67% of the light-blocking areas are blue. Similarly, when the mechanical smart window is placed into a minimum light-transmissivity state using only the third set of layers, the colored face of the mechanical smart window may appear to be a dark shade of yellow due to the mixture of the matte black light-blocking areas on the common layer with the yellow-colored light-blocking areas on the other layers of the third set. In other words, approximately 33% of the light-blocking areas visible to an observer are matte black, and approximately 67% of the light-blocking areas are yellow.

In some implementations, layers of a mechanical smart window may be configured with a graphic, logo, design, or other content (hereinafter “graphic”). In such implementations, the graphic may only be partially visible when such a mechanical smart window is in the maximum light-transmissivity state. When such a mechanical smart window is in the minimum transmissivity state, for example, zero transmissivity, the graphic may be completely visible. Each layer may include only the portions of the graphic which map to the layer when the mechanical smart window is in the minimum light-transmissivity state.

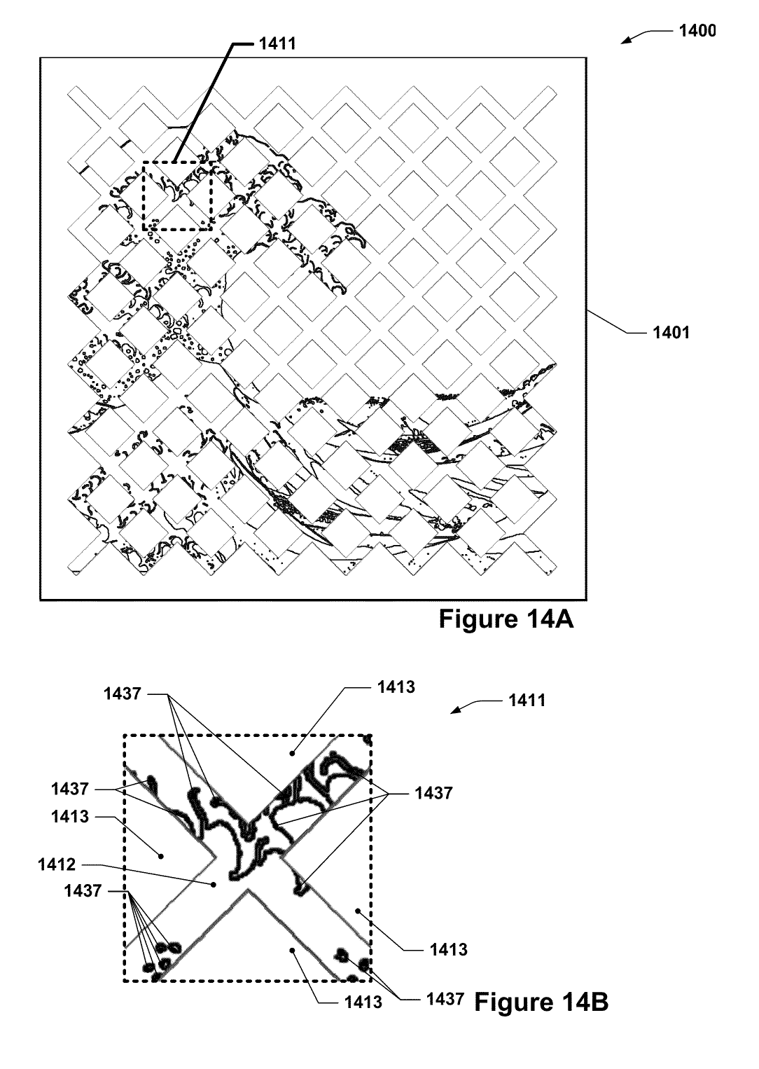

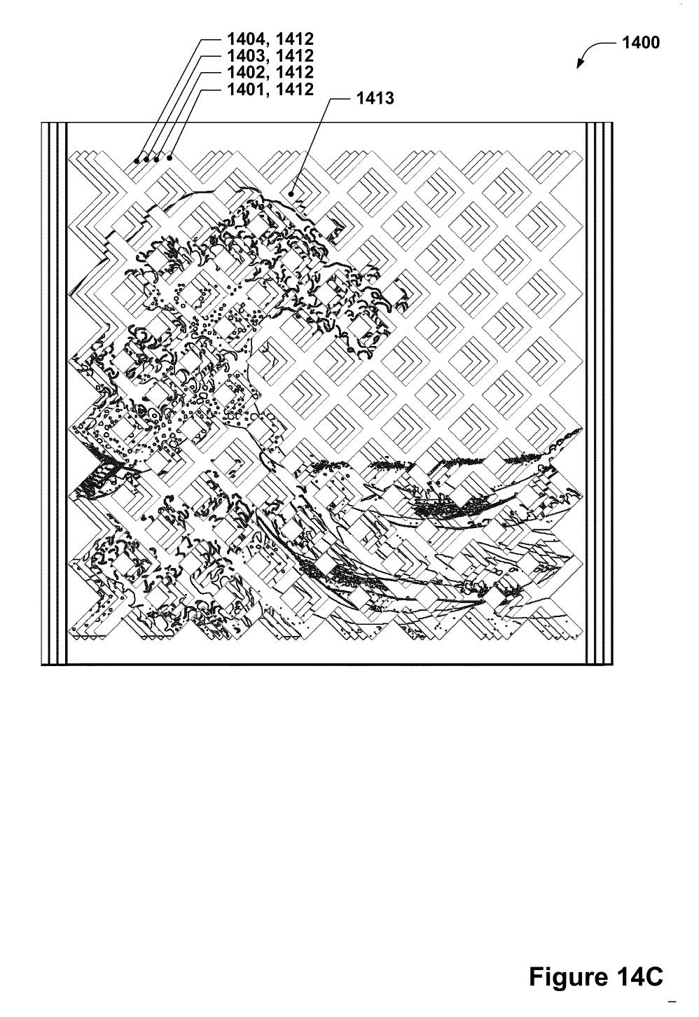

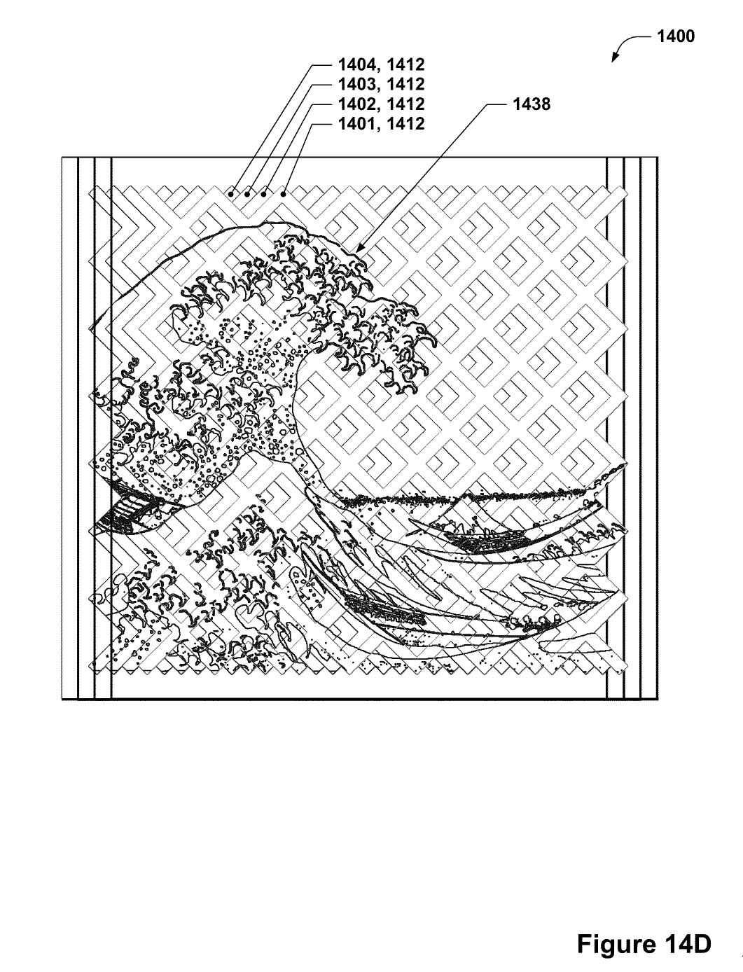

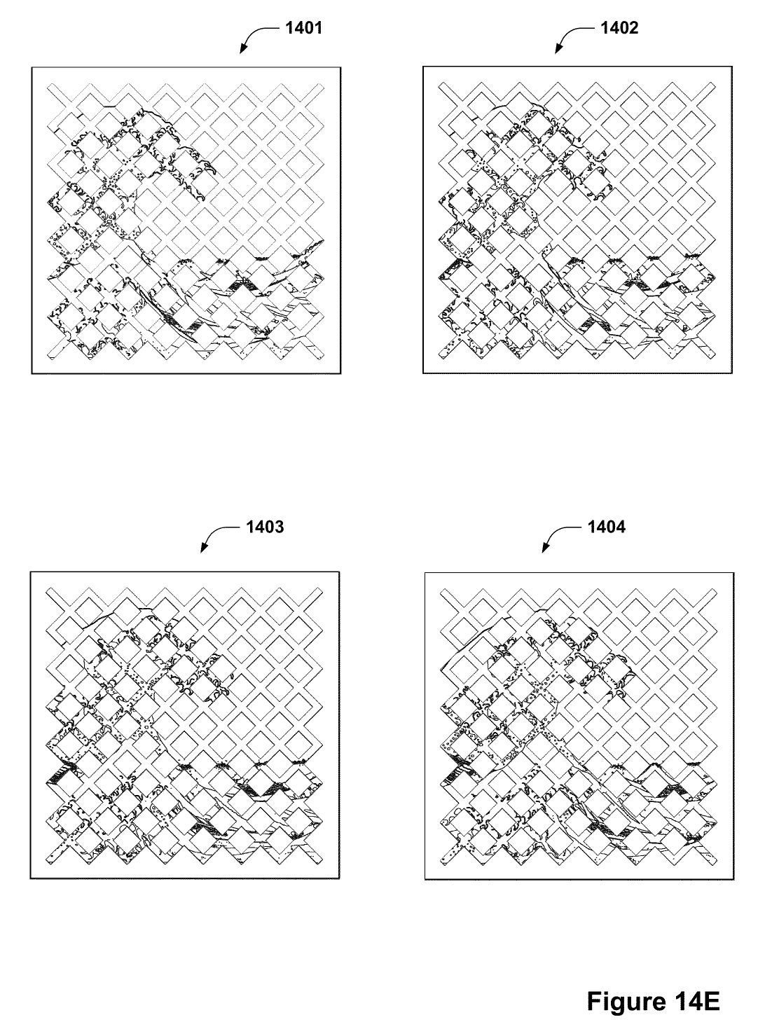

FIGS. 14A-14E depict an implementation of a mechanical smart window similar to that shown in FIGS. 7A-7D, but with the layers including a graphic. FIG. 14A shows a plan view of an example of a first layer for a four-layer mechanical smart window with portions of a graphic in the light-blocking areas. FIG. 14A may also be viewed as depicting a mechanical smart window 1400 in the maximum light-transmissivity state. This is because only a first layer 1401 is visible since it is the topmost layer in the mechanical smart window 1400. The first layer 1401 includes a 7×7 pattern array of a base pattern 1411, which includes a light-blocking area 1412 and light-transmitting areas 1413.

FIG. 14B shows an example of a base pattern for the first layer of FIG. 14A. The light blocking area 1412 of each instance of the base pattern 1411 also includes portions 1437 of the graphic. The portions 1437 of the graphic included in each instance of the base pattern 1411 may be different from instance to instance.

FIG. 14C shows a plan view of an example of a mechanical smart window using the first layer of FIG. 14A and three additional layers with portions of the graphic in the light-blocking areas; the mechanical smart window is shown in an intermediate light-transmissivity state. In the configuration shown in FIG. 14C, the mechanical smart window 1400 is partially transitioned between the maximum light-transmissivity state and the minimum light-transmissivity state. As portions of a second layer 1402, a third layer 1403, and a fourth layer 1404 are revealed due to the shift of each layer with respect to the adjacent layer or layers, additional portions 1437 of the graphic on the light-blocking areas 1412 of the second layer 1402, the third layer 1403, and the fourth layer 1404 may be revealed.

FIG. 14D shows a plan view of the example of the mechanical smart window shown in FIG. 14C in the minimum light-transmissivity state. As can be seen, a graphic 1438 has been formed by aligning the portions 1437 on the first layer 1401, the second layer 1402, the third layer 1403, and the fourth layer 1404 such that graphic 1438 is shown in its entirety when the mechanical smart window 1400 is placed in the minimum light-transmissivity state. The graphic 1438, in this case, is a line art reproduction of a portion of Katsushika Hokusai's The Great Wave Off Kanagawa, although other content may be used as well, including full-color photographs or prints. In some implementations, a second graphic may be placed on the opposite side of the layers of a mechanical smart window.

FIG. 14E shows a plan view of the example of the four individual layers of the mechanical smart window shown in FIGS. 14C and 14D. FIG. 14E shows the first layer 1401, the second layer 1402, the third layer 1403, and the fourth layer 1404 separately. As can be seen, the portions 1437 of the graphic 1438 included on the light-blocking area 1412 of each of the layers varies from layer to layer. In FIG. 14E, some of the portions 1437 may also include some material which is not visible when the graphic 1438 is fully visible. For example, some of the portions 1437 in the light-blocking layer 1412 of the second layer 1402 may be in regions of the light-blocking layer 1412 which will be overlaid by the light-blocking layer 1412 of the first layer 1401 in the minimum light-transmissivity state. For example, in the fourth layer 1404, the portions 1437 in the region where the / and the \ of the light-blocking area 1412 cross may be the only portions 1437 on the fourth layer 1404 which may be visible when the graphic 1438 is fully revealed in the minimum light-transmissivity state. Other portions 1437 which are outside of the cross-over region of the light-blocking area 1412 of the fourth layer 1404 may not be visible and may be omitted from the fourth layer 1404. Similar techniques may be practiced on other layers in the mechanical smart window 1400. In some implementations, there will be no or little overlap between the light-blocking areas 1412 on different layers and thus no overlap between the portions 1437.

Mechanical smart windows with graphic content may transform a utilitarian transparent surface into a visually-arresting artwork. While evidence of the graphic 1438 is visible on the first layer 1401 when the mechanical smart window 1400 is in the maximum light-transmissivity state as shown in FIG. 14A, such evidence may be much more difficult to discern by a human observer in actual implementation. The size and arrangement of the light-blocking layers 1412 may be sufficiently small or fine enough that the human eye cannot discern the fine detail in the portions 1437 unless in very close proximity to the mechanical smart window 1400. The dynamic range of a human eye may also assist in “masking” the portions 1437 which are visible from human sight when the mechanical smart window 1400 is in the maximum light-transmissivity state. For example, the contrast between the light shining through the mechanical smart window 1400 and the portions 1437 on the light-blocking areas 1412 may be large enough to prevent a human eye from effectively discerning the portions 1437 at all. This is similar to the effect which occurs when taking a photograph of a strongly-backlit subject—the subject may only be visible as a silhouette, and no features of the subject other than the general silhouette outline may be visible.

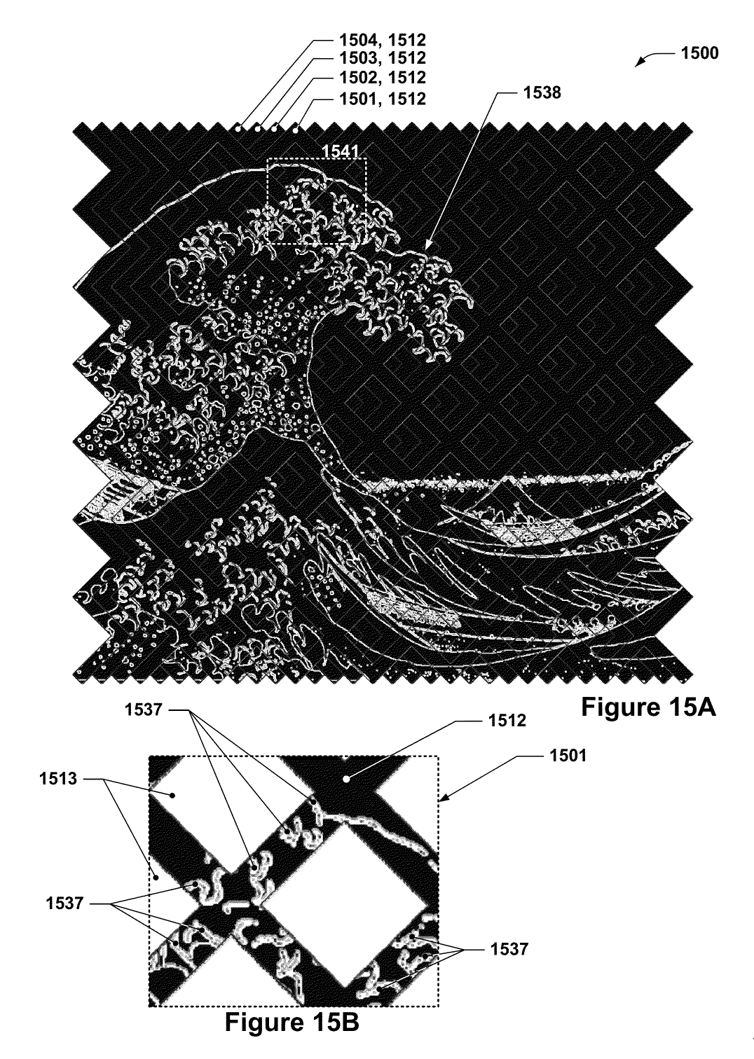

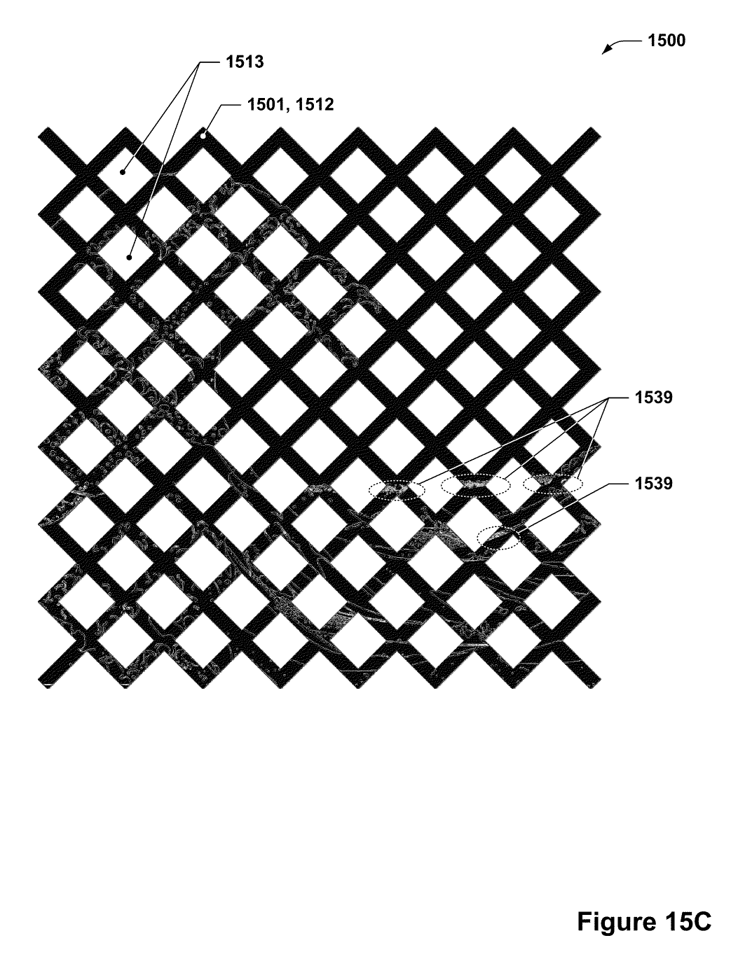

Another implementation of a mechanical smart window with a graphic is depicted in FIGS. 15A-15C. In FIGS. 15A-15C, a graphic 1538 is formed by rendering portions 1537 of light-blocking areas 1512 transparent. To clarify, the light-blocking areas 1512 may, in general, block most perpendicularly-incident light, but may also allow limited light transmission through the portions 1537.

FIG. 15A shows a plan view of an example of a mechanical smart window with four layers including a light-transmissivity graphic with the mechanical smart window in the minimum light-transmissivity state. In FIG. 15A, a mechanical smart window 1500 is configured such that light-transmitting areas 1513 are entirely overlapped by the light-blocking areas 1512 in a manner similar to the minimum light-transmissivity state of the mechanical smart window 1300 shown in FIG. 13D, except that light is allowed to shine through the mechanical smart window 1500 via the portions 1537 in this state. This causes the graphic 1538 to be displayed in an illuminated outline, similar to the effect achieved by holding an opaque stencil of the graphic 1538 in between the viewer and a light source. The area of a first layer 1501 contained within area 1541 is reproduced in a detail view in FIG. 15B.

FIG. 15B shows a detail view of a portion of one layer of the example of the mechanical smart window shown in FIG. 15A. The light-transmitting areas 1513 of the first layer 1501 are visible, as is the light-blocking area 1512. Also visible are the portions 1537 on the first layer 1501.

FIG. 15C shows a plan view of the example of the mechanical smart window of FIG. 15A in the maximum light-transmissivity state. In FIG. 15C, the mechanical smart window 1500 is configured such that the light-blocking areas 1512 of the first layer 1501, the second layer 1502, the third layer 1503, and the fourth layer 1504 are aligned over each other. As a result, light which is perpendicularly-incident to the first layer 1501, the second layer 1502, the third layer 1503, and the fourth layer 1504 is able to pass through the light-transmitting areas 1513 while being largely blocked by the light-blocking areas 1512. In the pictured configuration, most of the portions 1537 of the light-blocking area 1512 of the first layer 1501 overlap regions of the light-blocking areas 1512 of other layers which do not also include the portions 1537. Thus, light which may seep through the portions 1537 in one of the light-blocking areas 1512 may be blocked by regions without the portions 1537 in other of the light-blocking areas 1512. However, in some regions, corresponding portions 1537 in each of the light-blocking areas 1512 may align and allow perpendicularly-incident light to seep through the light-blocking areas 1512 within those regions. For example, seepage regions 1539 in FIG. 15A represent regions where the light-blocking areas 1512 of the first layer 1501, the second layer 1502, the third layer 1503, and the fourth layer 1504 all include portions 1537 which allow light through the light-blocking areas 1512.

An additional effect may be realized when the portions 1537 are configured to transmit light of only certain wavelengths through the light-blocking areas 1512. For example, some of the portions 1537 of the graphic 1538 may be untinted, but other of the portions 1537 of the graphic 1538 may be tinted various shades of blue. This may cause the graphic 1538 to be displayed in various colors, heightening the dramatic and artistic effect. At the same time, the light-transmitting areas 1513 may be untinted, resulting in a mechanical smart window which generally transmits broad-spectrum white light in the maximum light-transmissivity state (and some color-filtered light through any of the seepage regions 1539 present), but which transmits color-filtered light through the graphic 1538 in the minimum light-transmissivity state.

In some implementations, the “light-blocking areas” may only block light of certain polarity, and the “light-transmitting areas” may only transmit light of a different polarity. In such light-polarized implementations, the terms “light-blocking” and “light-transmitting” may no longer serve as appropriate labels for the two types of area which may form a base pattern. For the purposes of discussion regarding light-polarized mechanical smart window implementations and to avoid confusion with regard to the earlier discussions of mechanical smart windows, the two different types of areas which form a base pattern in a light-polarized implementation will be referred to as “first polarity areas” and “second polarity areas.” Such polarization may be achieved, for example, by applying different polarized optical coatings to a layer. In some implementations, one polarized optical coating may be applied to recessed areas of the layer, and a different polarized optical coating may be applied to non-recessed areas of the layer.

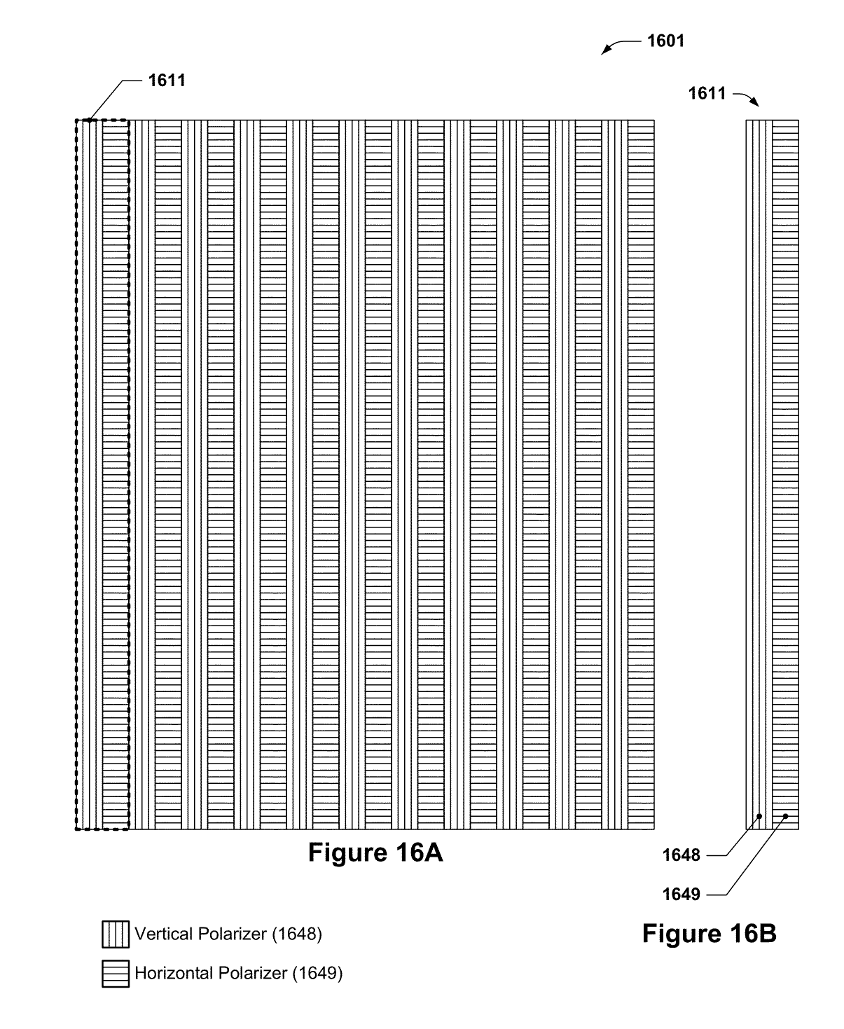

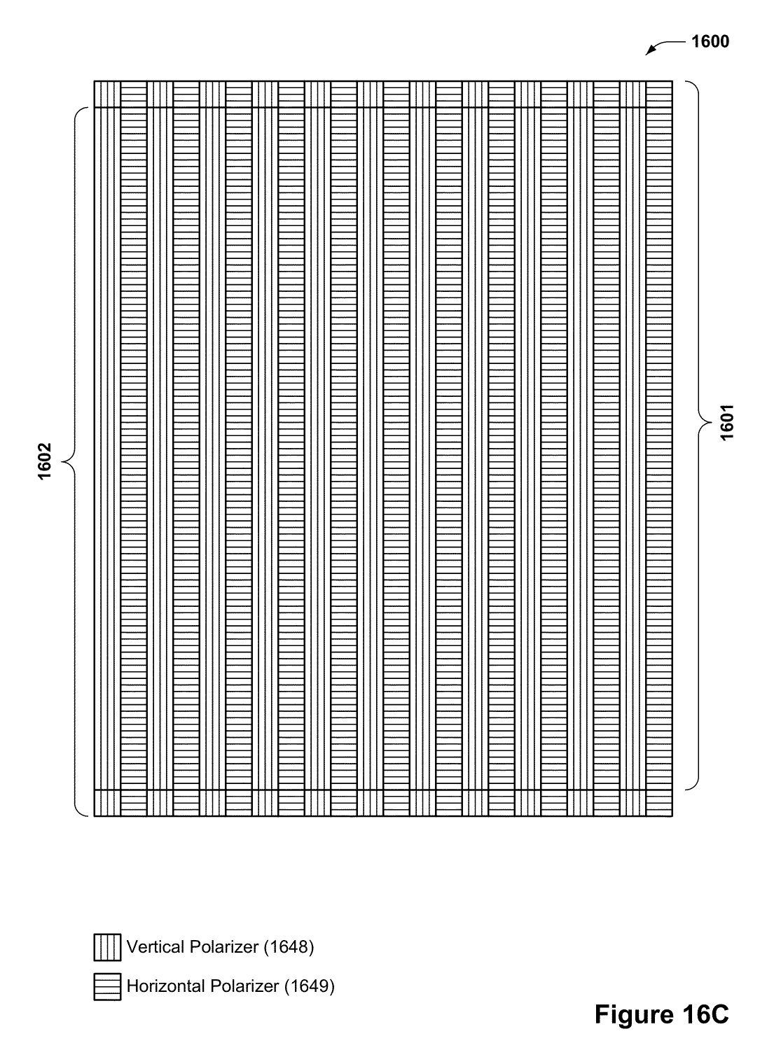

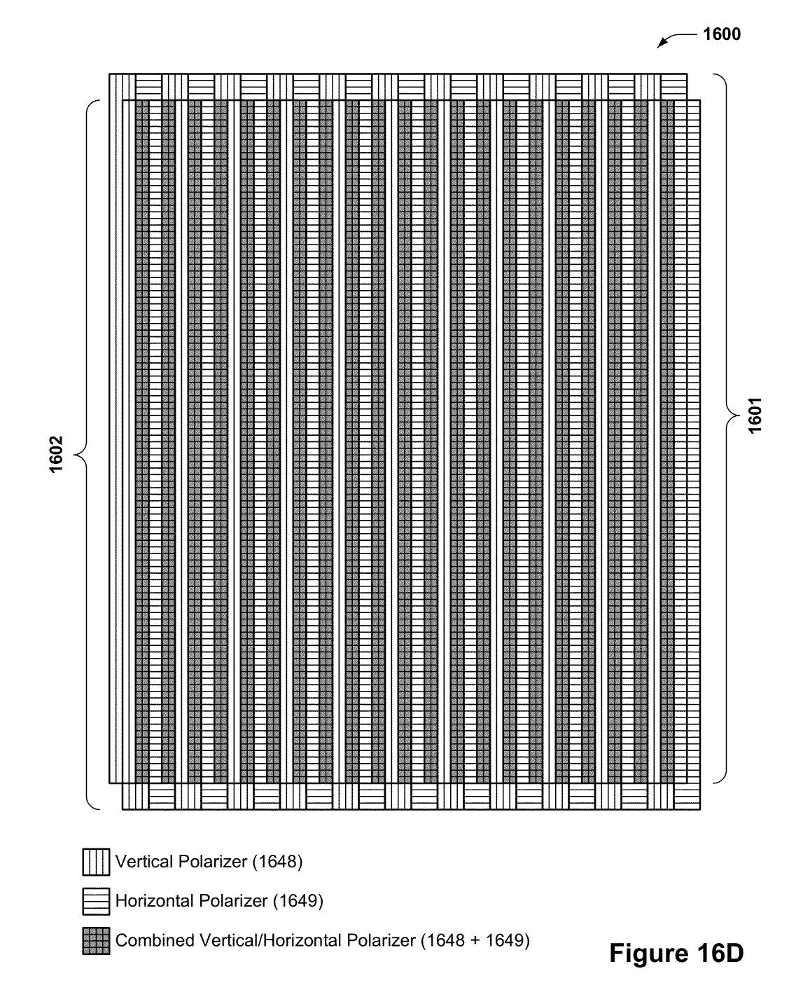

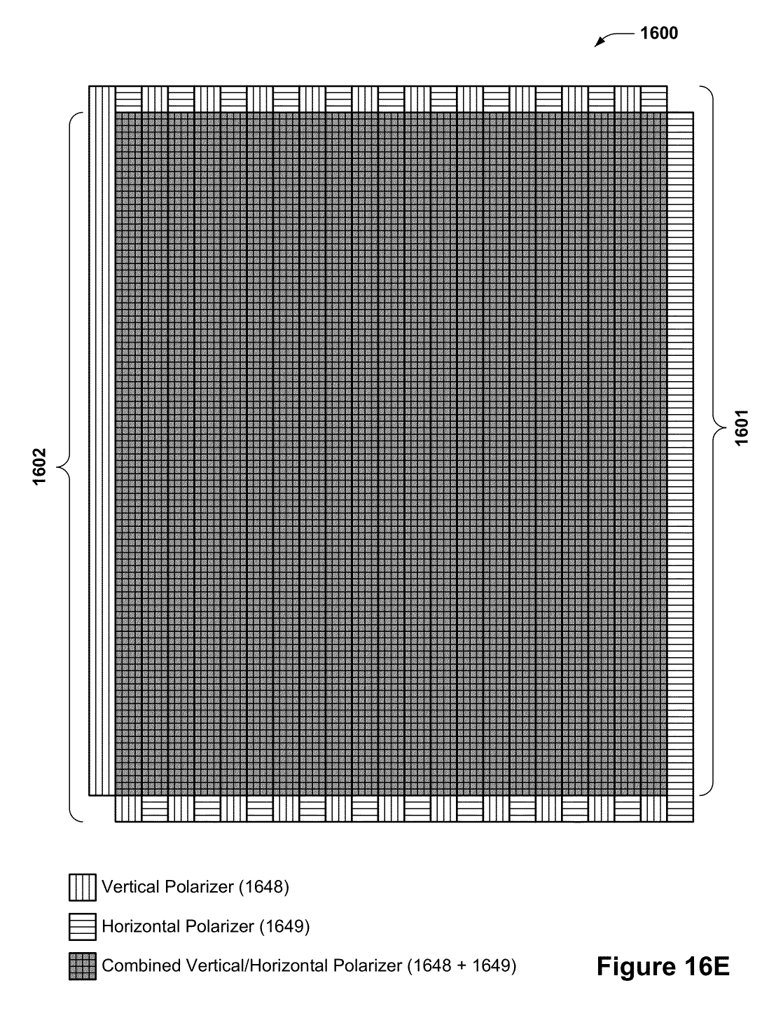

FIG. 16A shows a plan view of an example of a first layer for a mechanical smart window utilizing polarizers. A first layer 1601 which includes 11 instances of base pattern 1611 is shown in FIG. 16A. In this example, the base pattern instances completely fill the first layer 1601 and are arranged in a single-dimensional, linear pattern array. Alternative implementations may have different configurations of the first and second polarity areas. In some such implementations, the first and second polarity areas may be arranged into a checkerboard pattern similar to those shown in FIGS. 1A through 2G.

FIG. 16B shows an example of a base pattern for the first layer of FIG. 16A. The base pattern 1611 consists of two substantially equal-sized areas: first polarity area 1648, and second polarity area 1649. The first polarity area 1648 and the second polarity area 1649 are both long enough to span the first layer 1601 from the upper edge to the lower edge of the first layer 1601. In this example, the first polarity area 1648 is vertically polarized, and the second polarity area 1649 is horizontally polarized. Other configurations may be used as well, e.g. implementations wherein the first polarity area 1648 is configured to polarize light substantially in a first plane and the second polarity area 1649 is configured to polarize light in a second plane that is substantially orthogonal to the first plane. In some implementations, such as those where a non-zero minimum light-transmissivity state is desired, the angular difference between the polarizations of the first polarity area 1648 and the second polarity area 1649 may be other than 90 degrees.

FIG. 16C shows a plan view of an example of a mechanical smart window utilizing the first layer of FIG. 16A in a maximum light-transmissivity state. The first layer 1601 is shown overlaid with a second layer 1602 to form mechanical smart window 1600 in FIG. 16C. The mechanical smart window 1600 is a two-layer mechanical smart window in this example. To assist in visualizing FIGS. 16C-16E, the first layer 1601 and the second layer 1602 are shown shifted vertically from each other, although in actual practice these edges would likely be aligned with each other in this example. As a result, a portion of each layer is visible in each FIG. 16C-16E which is not interacting with the other layer in the mechanical smart window 1600. In this example, the first layer 1601 and the second layer 1602 are identical to each other, much as in the mechanical smart window 700 shown in FIGS. 7A, 7C, and 7D.

In FIG. 16C, the first polarity areas 1648 of the first layer 1601 and the second layer 1602 are overlaid and coextensive with each other. The same is true of the second polarity areas 1649 of the first layer 1601 and the second layer 1602. However, because the polarity of the overlaying areas is the same, light may pass through the first polarity area 1648 and the second polarity area 1649 largely unhindered.

In FIG. 16D, the first layer 1601 and the second layer 1602 have been shifted relative to each other by a distance approximately 25% of the width of the base pattern 1611. As a result, approximately 50% of each first polarity area 1648 and each second polarity area 1649, with the exception of the first polarity area 1648 on the far left of the first layer 1601 and the second polarity area 1649 on the far right of the second layer 1602, overlap. In the overlapped areas, the first polarity areas 1648 and the second polarity areas 1649 combine to form, in this example, a combined vertical/horizontal polarizer which effectively blocks any light transmission.

In FIG. 16E, the first layer 1601 and the second layer 1602 have been shifted relative to each other by a distance approximately 50% of the width of the base pattern 1611. As a result, approximately 100% of each first polarity area 1648 and each second polarity area 1649, with the exception of the first polarity area 1648 on the far left of the first layer 1601 and the second polarity area 1649 on the far right of the second layer 1602, overlap. Thus, in the configuration shown in FIG. 16E, the mechanical smart window 1600 has been placed in the minimum light-transmissivity state.

A polarized implementation of a mechanical smart window, such as that described above, differs in some respects from the mechanical smart window implementations discussed earlier in this paper. One difference, which has already been noted above, is that each area of a base pattern transmits light. Another difference is that approximately equal amounts of any unpolarized light striking the base patterns are transmitted through the base patterns in the maximum light-transmissivity state, regardless of whether the light passes through the first polarity area or the second polarity area. This may present a more uniform appearance to an outside observer and may be more useful for situations in which an observer may be positioned close to the mechanical smart window.

Various modifications to the implementations described in this disclosure may be readily apparent to those having ordinary skill in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

It will be understood that unless features in any of the particular described implementations are expressly identified as incompatible with one another or the surrounding context implies that they are mutually exclusive and not readily combinable in a complementary and/or supportive sense, the totality of this disclosure contemplates and envisions that specific features of those complementary implementations can be selectively combined to provide one or more comprehensive, but slightly different, technical solutions. It will therefore be further appreciated that the above description has been given by way of example only and that modifications in detail may be made within the scope of this disclosure.

What is claimed is:

1. An apparatus comprising:
a plurality of layers including a first layer and a second layer, the first layer and the second layer each including light-blocking areas and light-transmitting areas;
a support structure, the support structure configured to support the first layer and the second layer; and
a control system configured for moving at least one of the first and second layers between a first configuration and a second configuration with respect to each other, wherein:
in the first configuration, the light-blocking areas of the first layer substantially overlay, and are substantially coextensive with, the light-blocking areas of the second layer and the light-transmitting areas of the first layer substantially overlay, and are substantially coextensive with, the light-transmitting areas of the second layer, and
in the second configuration, the light-blocking areas of the first layer at least partially overlap the light-transmitting areas of the second layer, and the light-blocking areas of the second layer at least partially overlap the light-transmitting areas of the first layer.

2. The apparatus of claim 1, wherein:
the plurality of layers includes one or more intermediate layers disposed between the first layer and the second layer, wherein:
each intermediate layer includes light-blocking areas and light-transmitting areas,
in the first configuration, the light-blocking areas of each intermediate layer substantially overlay, and are substantially coextensive with, the light-blocking areas of the first layer and the second layer, and the light-transmitting areas of each intermediate layer substantially overlay, and are substantially coextensive with, the light-transmitting areas of the first layer and the second layer, and
in the second configuration, the light-blocking areas of each layer partially overlap the light-transmitting areas of the other layers; and
the control system is further configured for moving the one or more intermediate layers between the first configuration and the second configuration.

3. The apparatus of claim 2, wherein each layer in the plurality of layers is offset from any neighboring layer by a substantially equal distance in a direction substantially normal to the layers.

4. The apparatus of claim 2, wherein, in the second configuration, each light-blocking area of each layer in the plurality of layers is shifted by a substantially equal distance with respect to a corresponding light-blocking area of any neighboring layer in a direction substantially parallel to the layer.

5. The apparatus of claim 2, wherein the control system is configured to move all of the layers in the plurality of layers between the first configuration and the second configuration simultaneously.

6. The apparatus of claim 2, wherein the support structure is further configured to:
support the intermediate layers; and
prevent the first layer, the second layer, and the intermediate layers from contacting neighboring layers when the layers are in at least one of the first configuration and the second configuration.

7. The apparatus of claim 2, wherein, in the second configuration:
each light-transmitting area of each layer is completely overlapped by partial overlaps of the light-blocking areas of the other layers.

8. The apparatus of claim 7, wherein:
each layer in the plurality of layers includes a portion of a graphical image on one side, and,
in the second configuration, the portions of the graphical image align to depict the graphical image.

9. The apparatus of claim 1, wherein the light-blocking areas and light-transmitting areas of each layer form a periodic pattern.

10. The apparatus of claim 9, wherein the periodic pattern is selected from the group consisting of: a checkerboard pattern, a grid pattern of light-blocking areas with light-transmitting areas in the grid interstices, a grid pattern of light-transmitting areas with light-blocking areas in the grid interstices, a parallel-line grating pattern of light-blocking areas with a light-transmitting area between each light blocking area, and a grid pattern of light-blocking areas with light-transmitting areas in the grid interstices with the grid pattern oriented at approximately 45° to a direction of movement of the first layer.

11. The apparatus of claim 1, wherein:
at least one layer is made of a transparent material; and
the light-blocking areas of the at least one layer are formed on or in the transparent material.

12. The apparatus of claim 1, wherein:
the layers are each made of an opaque material; and
the light-transmitting areas are formed by interstices in the opaque material.

13. The apparatus of claim 1, wherein the area ratio of the light-blocking areas to the light-transmitting areas for a layer in the plurality of layers is approximately 1:X, where X equals the number of layers in the plurality of layers minus 1.

14. The apparatus of claim 1, further comprising:
at least one first pivot arm, a first side of each layer being rotatably connected with the at least one first pivot arm, and the at least one first pivot arm being configured to rotate about a first pivot point,
wherein each layer is configured to translate with respect to, and remain parallel to, the other layers during rotation of the at least one first pivot arm about the first pivot point.

15. The apparatus of claim 1, wherein the light-blocking areas of at least one layer have a reflective coating on one side.

16. The apparatus of claim 1, wherein the light-blocking areas of at least one layer have a non-reflective coating on one side.

17. The apparatus of claim 1, further comprising:
an enclosure including two substantially parallel, transparent or translucent walls, wherein the layers are suspended within the enclosure and are substantially parallel to the two transparent or translucent walls; and
a fluid, wherein the fluid is contained within the enclosure and the layers are immersed in the fluid.

18. The apparatus of claim 1, wherein the light-blocking areas block or reflect substantially all visible light incident on the light-blocking areas.

19. The apparatus of claim 1, wherein:
the light-blocking areas are substantially transparent to light of a first wavelength incident on the light-blocking areas,
the light-blocking areas block or reflect light of a second wavelength incident on the light-blocking areas, and
the first wavelength and the second wavelength are both in the visible light spectrum and are different from each other.

20. The apparatus of claim 1, wherein:
the light-blocking areas are substantially transparent to light of a first wavelength incident on the light-blocking areas,
the light-blocking areas block or reflect light of a second wavelength incident on the light-blocking areas,
the first wavelength is in the visible spectrum, and
the second wavelength is in the ultraviolet or the infrared spectrum.

21. The apparatus of claim 1, wherein:
the light-blocking areas are substantially transparent to light with a first polarity incident on the light-blocking areas,
the light-blocking areas substantially block or reflect light with a second polarity incident on the light-blocking areas, and
the first polarity and the second polarity are different.

22. An apparatus comprising:
a first layer including first means for blocking light and first means for transmitting light;
a second layer including second means for blocking light and second means for transmitting light; and
means for moving the first layer and the second layer between a first configuration and a second configuration, wherein:
in the first configuration, the first means for blocking light substantially overlay, and are substantially coextensive with, the second means for blocking light and the first means for transmitting light substantially overlay, and are substantially coextensive with, the second means for transmitting light, and
in the second configuration, the first means for blocking light at least partially overlap the second means for transmitting light and the second means for blocking light at least partially overlap the first means for transmitting light.

23. The apparatus of claim 22, further comprising:
one or more intermediate layers, each intermediate layer including intermediate means for blocking light and intermediate means for transmitting light, wherein the means for moving is further configured for moving the one or more intermediate layers between the first configuration and the second configuration, wherein:
in the first configuration, the one or more intermediate means for blocking light substantially overlay, and are substantially coextensive with, the first means for blocking light and the second means for blocking light and the one or more intermediate means for transmitting light substantially overlay, and are substantially coextensive with, the first means for transmitting light and the second means for transmitting light, and
in the second configuration, the means for blocking light for each layer partially overlap each of the means for transmitting light on the other layers.

24. The apparatus of claim 22, wherein, in the second configuration, each means for transmitting light of each layer is completely overlapped by partial overlaps of each means for blocking light of the other layers.

25. A method of manufacturing a continuously-tunable light-transmissive device, the method comprising:
forming a first layer, the first layer including light-transmitting areas and light-blocking areas; and
forming a second layer, the second layer including light-transmitting areas and light-blocking areas, wherein the light-transmitting areas and the light-blocking areas are arranged in substantially the same manner on the first layer as they are on the second layer.

26. The method of claim 25, the method further comprising:
forming the first layer by depositing an opaque material on a transparent substrate.

27. The method of claim 25, the method further comprising:
forming the first layer by removing portions of material from an opaque substrate.

28. The method of claim 25, the method further comprising:
forming the first layer by weaving opaque strands together to form a mesh.

29. The method of claim 25, the method further comprising:
connecting the first layer to a positioning mechanism; and
connecting the second layer to the positioning mechanism, wherein the positioning mechanism is configured to:
move the first layer and the second layer between a first configuration to a second configuration, wherein:
in the first configuration, the light-blocking areas of the first layer substantially overlay, and are substantially coextensive with, the light-blocking areas of the second layer and the light-transmitting areas of the first layer substantially overlay, and are substantially coextensive with, the light-transmitting areas of the second layer; and
in the second configuration, the light-blocking areas of each layer at least partially overlap the light-transmitting areas of the other layers.

30. The method of manufacturing of claim 29, the method further comprising:
connecting one or more intermediate layers to the positioning mechanism and in between the first layer and the second layer, wherein:
each intermediate layer includes light-blocking areas and light-transmitting areas, and
the positioning mechanism is further configured to move each intermediate layer between the first configuration and the second configuration, wherein:
in the first configuration, the light-blocking areas of each intermediate layer substantially overlay, and are substantially coextensive with, the light-blocking areas of the first layer and the light-blocking areas of the second layer and the light-transmitting areas of each intermediate layer substantially overlay, and are substantially coextensive with, the light-transmitting areas of the first layer and the light-transmitting areas of the second layer; and
in the second configuration, the light-blocking areas of each layer partially overlap the light-transmitting areas of the other layers.

31. The method of manufacturing of claim 30, the method further comprising:
inserting the positioning mechanism and the connected first layer, second layer, and one or more intermediate layers into a gap between two pieces of transparent or translucent material fixed relative to each other; and
rigidly supporting at least one of the positioning mechanism, the first layer, the second layer, or the one or more intermediate layers with respect to the two pieces of transparent or translucent material.

32. The method of manufacturing of claim 31, the method further comprising:
joining the two pieces of transparent or translucent material to form an enclosure; and
filling the enclosure with a fluid.

33. An apparatus, comprising:
a first layer and a second layer, each of the first layer and the second layer having alternating first polarity areas and second polarity areas, the first polarity areas being configured to polarize light substantially in a first plane and the second polarity areas being configured to polarize light in a second plane that is substantially orthogonal to the first plane;
a support structure configured to support the first layer and the second area; and
a control system configured for moving at least one of the first and second layers between a first configuration and a second configuration with respect to each other, wherein:
in the first configuration, the first polarity areas of the first layer substantially overlay, and are substantially coextensive with, the first polarity areas of the second layer and the second polarity areas of the first layer substantially overlay, and are substantially coextensive with, the second polarity areas of the second layer, and
in the second configuration, the first polarity areas of the first layer at least partially overlap the second polarity areas of the second layer, and the first polarity areas of the second layer at least partially overlap the second polarity areas of the first layer.

34. The apparatus of claim 33, wherein the first polarity areas and second polarity areas are arranged in a linear pattern array.

35. The apparatus of claim 33, wherein the first polarity areas and second polarity areas are arranged in a checkerboard pattern.
